(19) United States
(12) Patent Application Publication
(10) Pub. No.: US 2009/0125419 A1
(43) Pub. Date: May 14, 2009

(54) Method and System for Selling Complex Products on a Distributed Network Using Syndicated Services

(76) Inventor: Clifford Shannon Barney, (US)

Correspondence Address: Clifford Barney, 6710 Eldermill Ln, Gainesville, VA, 20155, US

(21) Appl. No.: 11/939,567

(22) Filed: Nov. 14, 2007

(51) Int. Cl. G06Q 30/00; G06F 7/00; G06F 3/048; G06F 17/30

(52) U.S. Cl. 705/27; 707/102; 715/833; 707/9; 707/E17.005; 707/E17.055

(57) ABSTRACT

A software object representing a product to be sold on an Internet-based web site is automatically transmitted from a central computer system to a requesting browser at the direction of a remote user. Upon receipt, the browser executes the object, rendering sufficient structure, style and descriptive attributes such that the remote user is able to configure and prepare for purchase, within a single page-view, a complex product with multiple interdependent variations against a complex pricing model with no further interaction with the central computer system.

### FIELD OF THE INVENTION

This invention relates to computers and computer systems and particularly to a method and system for selling complex products on a distributed network such as the Internet.

### BACKGROUND OF THE INVENTION

The buying and selling of products on the Internet has grown dramatically over the past decade, with ever-increasing varieties of products available, and increasingly powerful methods for buyers and sellers to conduct transactions. Early E-Commerce systems involved the selling of relatively simple products—items that had few variations, simple one-column pricing, and were sold by the piece. This included books, clothing, music and other items intended primarily for the retail consumer market. As companies set up more advanced E-Commerce portals, the need to sell more complex products arose. This included items that had many levels of variations such as size, color or style; or had multi-tier pricing; or had pricing based upon a unit of measure such as length or weight.

In E-Commerce, two primary factors differentiate complex products from simple products: variations and pricing. Many products have variations that must be selected by the buyer in order to execute the transaction. In an Internet-based E-Commerce system, providing the means to select from several variations such as color or size can be accomplished using various well-known methods. However, implementations of such methods can become quite complex when there are multiple levels of variations, and not all combinations of attributes within each variation are intended to be selectable. Such interdependency is a common feature of products in the industrial marketplace, in which a ‘parent’ product may have hundreds of ‘child’ variants, with unique SKU's and pricing. The efficient representation of products with interdependent variations is one of the most pressing challenges in E-Commerce today.

In addition to pricing and SKU's, other descriptive elements of a product may be associated to specific combinations of variation attributes. Such associative behavior may be linked to product names, descriptions, column pricing labels, images, etc. Such associative behavior is difficult to implement with existing methods.

Another challenge facing Internet merchants is in developing intuitive, efficient and visually appealing methods to sell complex products that are sold in bulk. This includes products sold in units of measure, e.g., linear foot, square meter, cubic yard, etc. While various methods for selling a product in bulk on the Internet are well-established, methods that can accommodate both bulk and fixed pricing for the same product are relatively immature and inefficient. For example, factory flooring may be sold in specific dimensions such as 2′×5′ or 3′×6′, and also available in custom-cut lengths from a pre-cut 3′ wide roll. The first two variants would have a fixed price, but the third would have to be priced by the square foot, using a length entered manually by the buyer. Methods for incorporating both pricing models within a single instance of an Internet-based product are difficult to implement, inefficient to use, and prone to functionality errors.

The manual entry of units of measure by the customer is itself an area of technical difficulty, because the validation of such entries cannot always be easily integrated into the accompanying E-Commerce system. In actual practice, manual entries may be out-of-bounds of minimum and maximum values, or may not adhere to a common divisor. For example, the factory flooring in the preceding paragraph may be sold in custom-cut lengths, with the minimum purchasable length being 5 ft, and the maximum length in a supply roll being 100 ft. The merchant would need to validate any entries made by a prospective customer to prevent attempts to purchase lengths less than 5 ft or greater than 100 ft. Similarly, the merchant may only be capable of custom-cutting the factory flooring along whole number units that are a multiple of 5, e.g., 10 ft, 15 ft, 20 ft, etc. The validation method would need to prevent customers from attempting to order lengths that are not multiples of 5. Even more advanced validation algorithms can be implemented, given that methods for validating such entries exist within an E-Commerce system. For example, a validation could be of sufficient complexity that it can only be represented by a series of mathematical statements.

Internet merchants selling products for the retail marketplace generally structure their web sites for design impact and simplicity, with products presented for maximum visual appeal, and ease of purchase. Retail pricing models are generally simple, with fixed pricing for each product. Variations are easily selected, and are rarely interdependent. In the industrial marketplace, however, pricing models can be quite complex because of the need to provide tier pricing to buyers, and the need to tether pricing to multiple pricing schedules. To be as competitive as possible, merchants need to provide the most attractive pricing they can to prospective buyers.

These four factors—variations, tier pricing, bulk pricing and schedule pricing—intersect to create extreme technical challenges for Internet merchants selling complex products. In many cases, merchants develop E-Commerce solutions that mimic the century-old catalog model, with large tables of rows and columns portraying available combinations of variation attributes along with tier pricing.

Another issue affecting Internet merchants is that the availability, pricing and feature sets of products are fairly dynamic, in that manufacturers and suppliers frequently change what products are available, modify variations and/or pricing. This creates a burden on merchants selling complex products because changes require the modification of records representing hundreds of possible variants of the same parent product class.

The invention described herein resolves the inherent difficulties of selling complex products on the Internet, with surprising efficiencies resulting for all parties to E-Commerce transactions: manufacturers and suppliers, merchants and customers. Centralization of product information ensures that merchants are able to maintain an up-to-date portfolio of products and associated pricing, descriptive data and ancillary content. Shared tools allow merchants to encode complex products as software objects that can be instantly delivered to web pages. With such an infrastructure in place, manufacturers and suppliers are able to encourage the sale of complex products by providing tools that simplify the process for merchants, especially small-to-mid-size merchants with limited technology resources. Finally, customers are able to more intuitively select and purchase complex products by interacting with a single object rather than scanning listings containing hundreds or thousands of variants.

In computer systems, methods for storing records pertaining to various variation attributes of a parent product class are known. However, this invention describes a method of storing knowledge of the association between two or more such variation attributes in such a way that any descriptive element of a product can be associated to any combination of variation attributes. This unconventional approach to data modeling results in a novel means to bind not just pricing to specific combinations of variation attributes, but any descriptive element: SKU, images, descriptions, associated content, weight, etc. This approach increases the speed by which data store systems are able to locate and retrieve records pertinent to a specific combination of variation attributes. Furthermore, this invention describes a method by which any variation attribute can itself be associated to a variation class in a cascading model that allows for flexibility in designing dynamic product objects that contain executable code for rendering product variations.

Methods for retrieving executable code from remote computer systems are known, and methods for retrieving such code from within a web page using embedded commands are also known. However, the unconventional approach described herein yields executable code of surprising performance and efficiency. Furthermore, the centralization of the production process for creating such executable code, based upon a series of database clusters with independent access permissions, has resulted in a surprisingly efficient model for selling complex products on the Internet, one that greatly reduces the total cost of deployment for both manufacturer/suppliers and merchants.

Methods for performing validation of manually entered units of measure within a web page, with no interaction with the web server, are known. However, such methods have not been satisfactorily applied to the special needs of merchants selling complex products. This invention describes a method by which validation based on a series of mathematical statements can be embedded within a product object, yielding efficiencies for both merchants and customers.

Whereas previous approaches to E-commerce have failed to meet the needs of merchants selling complex products, it has been discovered that the buying process can be made more efficient for buyers and sellers alike by providing the means for buyers to interact with a single product object representing all possible combinations of selectable variations. Furthermore, such objects can be architected to perform functions conventionally performed by a web server: e.g., validation of manual entries, determination of product SKU's, calculation of pricing by units of measure, calculation of weight and the display of visual indicators that assist the customer in navigating a complex configuration. With sufficiently developed code, a buyer can interact with the product object to select from one or more variations, obtain real-time pricing and descriptive information, and execute the transaction.

### SUMMARY OF THE INVENTION

The invention includes a central computer configured to store a large number of records, each of which describes variants of a parent class of product. The information stored within each record can include product descriptive data, unique identifiers, shipping characteristics, images, associated documentation, variations, and other attributes.

A database management system resides on the central computer, and is accessible to remote users via a distributed network interface, such as the Internet. Two groups of administrators are provided remote read/write access: 1) manufacturers and suppliers of products to Internet-based merchants and 2) Internet-based merchants. Manufacturers and suppliers of products have authority to manage the source records of their products, which are stored in a primary database and not editable by merchants. Merchants have the authority to copy and configure records of product source records, configuring them to suit their own pricing, style and descriptive requirements. Merchant records are stored within a series of secondary databases, one for each Internet-based merchant granted access to the system.

In a preferred embodiment, authorized manufacturers and suppliers can interact with the primary database management system via a standard web browser. Using the primary database management system, administrators can create product records, modify existing records, and remove records no longer needed. The database management system also exposes certain of its internal functions as web services, allowing non-human administrators to perform certain database management tasks.

Similarly, authorized merchants can interact with the secondary database management system via a standard web browser. Using the secondary database management system, merchants can choose product records from various primary databases, add them to their ‘shadow’ database, and configure them as desired. Typically such configuration consists of creating merchant-specific pricing, selecting allowable product variations, and customizing certain style, descriptive and presentation characteristics.

The database management system is dual-permissioned, creating a clear separation between administrators who have authorization to manage primary product records, and those who have authorization to manage secondary product records. No manufacturer/supplier can manage records belonging to another manufacturer/supplier, nor any merchant. Nor can any merchant manage records belonging to another merchant, nor manufacturer/supplier.

Furthermore, manufacturers and suppliers can stipulate the conditions by which their product records can be made accessible to the secondary database management system. They can select certain merchants to have access to select groups of products, and may prevent portions of a product record from being accessible to certain merchants.

In a preferred embodiment, manufacturers/suppliers can configure pricing for products based upon four intersecting criteria: 1) variation attributes and combinations thereof, 2) tier pricing, 3) schedule pricing and 4) bulk pricing. Merchants can do the same, taking the pricing assigned to them by a manufacturer/supplier and refining it to meet their own pricing models. Merchants are allowed the option to universally change pricing based upon simple mark-up percentages, or can individually enter fixed pricing for each pricing record.

The primary database cluster managed by manufacturers and suppliers contains a database for storing product variation records, which describe all variations associated with a parent product class. When a product record is created, each variation is assigned a sequential rank in the hierarchy of variations. Each variation is tagged as either ‘required’ or ‘non-required’, denoting whether an attribute within that variation must be selected to fully define the product, and to allow it to be purchased. Each variation is also tagged as either ‘unique’ or ‘non-unique’, connoting whether more than one attribute can be selected simultaneously. Additional criteria can be added to each variation record, allowing for complex associations between variations to be created.

The primary database cluster also contains a database for storing product attribute records, which describe all attributes associated with a specific variation within a parent product class. Each attribute is assigned a sequential rank in the hierarchy of attributes within its assigned variation.

By scanning all records within the variations and attributes databases associated with a particular parent product class, an association map can be derived that establishes all possible combinations of variation attributes. Every combination of attribute associations is assigned a unique identifier called a ‘metakey’. This unique identifier is used throughout the primary and secondary database systems to bind product-specific information such as pricing and descriptive data to each unique combination of attributes. The metakey is itself a metadata container which self-describes the attribute associations to which it refers.

Within each merchant's secondary database are three databases for storing process objects, product objects and style objects. As the merchant configures each product, a software utility creates a product object, associates it to the parent product class, and stores it as a record in the product objects database. This record contains executable code intended to be delivered to an end-user computer and rendered by a standard web browser. A process object is created at the same time and stored in the process objects database. The process object contains executable code that provides dynamic functionality for the product object when rendered within the end-user web browser. Lastly, a style object is created and saved to the style objects database. The style object contains certain style parameters set by the merchant that are used by the web browser to render the product object.

In a preferred embodiment, commands to retrieve the process object, product object and style object are embedded into the HTML code of a web page. When the page is requested by an end-user, the objects are automatically requested, accessed by the secondary database management system in read-only mode, and delivered back to the end-user browser. The browser then executes the product object, which causes the product itself to render within the page, adhering to instructions contained within the style object. The customer is then provided dynamic functionality via the embedded process code object.

In a preferred embodiment, the product object is comprised of embedded code that, when executed, causes to be displayed an HTML-encoded object representing a product that may have one or more levels of variations, and one or more levels of tier pricing. The process object contains embedded code that recognizes user actions upon the product object, and triggers certain functions to activate. One function is the management of displayed product variations and attributes. The selection of an attribute within a variation triggers this function, which determines and causes to be displayed the allowable attributes in the next variation in the hierarchy. Another function detects the satisfactory selection of all required variations and triggers the activation of a function that populates the pricing fields, updates product descriptive data such as SKU's and descriptions, and reveals hidden features such as an ‘add to cart’ button and a quantity text entry form element. Another function monitors the selection of attributes that are associated with sub-variations, and causes to be displayed the appropriate sub-variation and relevant form elements and/or attribute information. Another function monitors the manual entry of data into text entry form elements within certain portions of the product object, ensuring that inputted data complies with certain constraints created by the merchant such as upper/lower limits, and/or a common divisor.

In a preferred implementation, the product object causes to be rendered a visible area into which product specific information is displayed. If the product has variations that must be selected prior to purchase, a visible indication of incompleteness is displayed, either through the use of colors, icons or messaging. The customer is instructed to click an icon to select variations which, when clicked, causes to be revealed a hidden area, showing the available attributes for the first variation in the hierarchy. As the customer selects an attribute within the first variation, a second hidden area is revealed, showing available attributes for the second variation in the hierarchy. As they select different attributes in the first variation, different attributes in the second level may appear. This process continues until they reach the last variation level. As they select the final attribute, visual indication of completeness is displayed, either through the use of colors, icons or messaging. With the product variations now satisfactorily selected, several hidden features are now revealed within the product object: a clickable icon associated with an ‘add to cart’ function, and a text entry field for entering a quantity. Also appearing in the product object is pricing information specific to the combination of attributes that have been selected. Other product descriptive information may also appear, such as a SKU specific to the combination of selected attributes, a modified description summarizing the selected attributes, and other information such as weight, product name, shipping specific data and more.

The product object is intended to be accessible to third-party E-Commerce modules that may or may not have any knowledge of the product being rendered on the web page. As part of the configuration process, merchants may configure universal settings within their accounts on the central computer that cause to be displayed certain embedded or hidden HTML form elements, configured with certain values. These form elements are intended to be further manipulated as part of the variation selection process, the final result being that the embedded or hidden HTML form elements contain sufficient information to allow the product to be purchased through a third-party E-Commerce system existent on the merchant web site.

In a preferred implementation, E-Commerce functionality is provided by the central computer. Each customer engaged in a session on a merchant web site is assigned a session ID using techniques well-known in the Internet software industry. This session ID is typically stored as a ‘cookie’ within the end user's browser, and passed to the merchant web server upon each subsequent page request. This session ID is also passed to the central computer along with requests for product objects. The product object contains embedded code that captures user selections on the product to one or more hidden HTML form elements embedded within the product object. When the customer clicks the ‘add to cart’ button, an event handler causes a request to be sent to the central computer, the purpose being to transmit relevant product metadata, the quantity entered into the quantity field, and the combination of variations that have been selected. The clicking of the ‘add to cart’ button does not cause the customer to leave the merchant site, or to even leave the current page. Visual indication of the ‘add to cart’ function is presented to the user in the form of a ‘shopping cart summary’ widget that is revealed, if not already displayed, within some portion of the merchant's web page. In a preferred embodiment, the shopping cart summary contains a summary of the number of items currently in the shopping cart, and their subtotal.

In similar fashion, all components of the E-Commerce transaction process reside on the central computer, and are delivered in real-time to appropriate pages on the merchant's web site. This includes customizable forms for gathering customer billing, shipping and payment information, and validating such information for accuracy and completeness. Customers are unaware that information is being retrieved behind-the-scenes from a central server, and the information presented renders just as it would if resident on the merchant's web server. The customer session on the merchant's web site is never interrupted. All activity takes place within the merchant's web site, even though all information pertinent to the E-Commerce transaction is actually flowing to and from the central server.

In another implementation of the invention, product objects, process objects and style objects may be periodically transmitted to and stored on databases located on the merchant's web server, with requests for said objects pointed locally rather than to the central server.

In another implementation of the invention, product objects, process objects and style objects may be periodically transmitted to and stored on databases locating on intermediate servers deployed for the express purpose of caching product objects.

### BRIEF DESCRIPTION OF THE DRAWINGS

Additional objects and features of the invention will be more readily apparent from the following detailed description and appended claims when taken in conjunction with the drawings, in which:

FIG. 1 is a schematic diagram of a product syndication system;

FIG. 2 is a schematic diagram of a portion of the system illustrated in FIG. 1;

FIG. 3 is a schematic diagram of a preferred embodiment of the invention showing a portion of the system illustrated in FIG. 2;

FIG. 4 is a schematic diagram and database model of a portion of the system illustrated in FIG. 1.;

FIG. 5 is a schematic diagram and database model of a portion of the system illustrated in FIG. 1;

FIG. 6 is a schematic diagram and database model of a portion of the system illustrated in FIG. 1;

FIG. 7 is a representation of a portion of the of a preferred embodiment showing HTML code, along with embedded references to remote software objects, collectively rendered as a viewable HTML document (web page);

FIG. 8 is a representation of a portion of a preferred embodiment showing the structure of a sample metakey;

FIG. 9 is a representation of a portion of a preferred embodiment showing the structure of a sample metakey;

FIG. 10 is a table showing the character map from which a metakey is built; and

FIG. 11 is a representation of a portion of a preferred embodiment showing the structure of a sample metakey;

FIG. 12 is a representation of a portion of a preferred embodiment showing the structure of a sample metakey;

FIG. 13 is a representation of a portion of a preferred embodiment showing the structure of a sample metakey;

FIG. 14 is a representation of a portion of a preferred embodiment showing the structure of a sample metakey;

FIG. 15 is a table showing sample metakeys, and their corresponding values for each variation;

FIG. 16 is a table showing sample statements for two scenarios in which variable ‘per unit’ pricing is calculated based on values inputted by an end-user;

FIG. 17 is a table showing a product with three variations, and three attributes per variation thereof, with another table showing unique metakeys pertaining to each combination of variation attributes;

FIG. 18 is a representation of a syndicated product as rendered in a preferred embodiment shown in FIG. 7;

FIG. 19 is a representation of a syndicated product as rendered in a preferred embodiment shown in FIG. 7;

FIG. 20 is a representation of a syndicated product as rendered in a preferred embodiment shown in FIG. 7;

FIG. 21 is a representation of a syndicated product as rendered in a preferred embodiment shown in FIG. 7;

FIG. 22 is a representation of a syndicated product as rendered in a preferred embodiment shown in FIG. 7;

FIG. 23 is a representation of a syndicated product as rendered in a preferred embodiment shown in FIG. 7;

FIG. 24 is a representation of a syndicated product as rendered in a preferred embodiment shown in FIG. 7;

FIG. 25 is a representation of a syndicated product as rendered in a preferred embodiment shown in FIG. 7;

FIG. 26 is a representation of a syndicated product as rendered in a preferred embodiment shown in FIG. 7;

FIG. 27 is a representation of a syndicated product as rendered in a preferred embodiment shown in FIG. 7.

### DESCRIPTION OF THE PREFERRED EMBODIMENTS

For the purposes of organizing the description of the overall system, the description of a preferred embodiment is separated into the following sections: System Architecture, System Data Model and System Functionality.

System Architecture

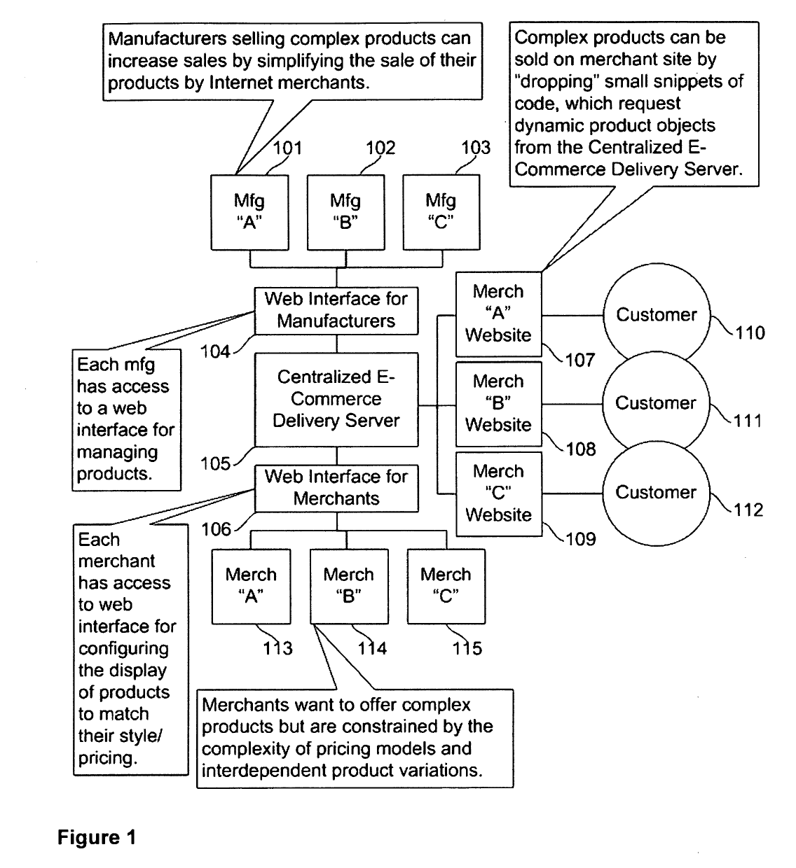

Referring to FIG. 1, a product syndication system is shown for storing product records in a central computer 105, delivered upon request to users 110, 111 and 112 viewing an HTML document (web page) located on merchant web sites 107, 108 and 109. The schematic shown in FIG. 1 shows the product syndication system as would be used in a preferred embodiment by three manufacturer/suppliers 101, 102 and 103; three merchants 113, 114 and 115; and three customers 111, 112 and 113; in actual practice, many more merchants and users are able to simultaneously use the system.

Access to the product syndication system is provided to manufacturers and suppliers via a web-based interface 104, which allows them to add, manage and remove product records from the central computer 105. The web-based interface 104 has two modes of operation: 1) an operational mode in which a human operator is provided a graphical user interface to perform certain functions pertaining to information stored, or intended to be stored, within the central computer 105 and 2) an operational mode in which a non-human operator is provided a non-graphical structured query interface to perform certain functions pertaining to information stored, or intended to be stored, within the central computer 105.

Access to the product syndication system is provided to merchants via a web-based interface 106, which allows them to add, manage and remove product records from the central computer 105. The web-based interface 106 has two modes of operation: 1) an operational mode in which a human operator is provided a graphical user interface to perform certain functions pertaining to information stored, or intended to be stored, within the central computer 105 and 2) an operational mode in which a non-human operator is provided a non-graphical structured query interface to perform certain functions pertaining to information stored, or intended to be stored, within the central computer 105.

In the preferred embodiment, continuous and simultaneous requests for product records stored on the central computer 105 are received from browsers being used by end users 110, 111 and 112 to view merchant web pages located on merchant web sites 107, 108 and 109. The central computer 105 validates certain features of each request, and upon successful validation, retrieves requested information and returns it to the browsers for subsequent rendering and display to the end users 110, 111 and 112.

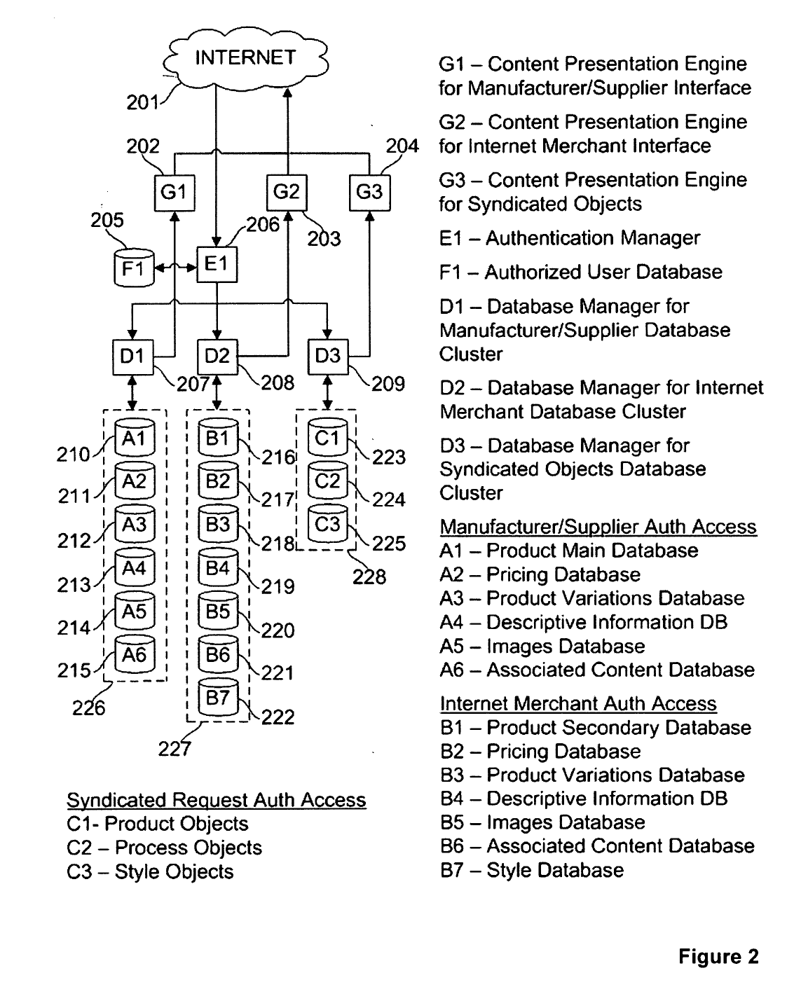

Referring now to FIG. 2, which shows a schematic of the database architecture of the central computer 105, consisting of three database clusters: 1) a manufacturer/supplier database cluster 226 consisting of a plurality of data stores, 2) a merchant database cluster 227 consisting of a plurality of data stores, and 3) a syndicated objects database cluster 228 consisting of a plurality of data stores.

Requests to execute certain functions upon data stored, or intended to be stored, within one or more data stores is received via the Internet 201 by means of either a graphical user interface or non-graphical structured query interface. Each request is received by an authentication manager 206, which retrieves certain user-specific information from an authorized user data store 205, and compares it to certain user-specific information contained within the request, by which means it approves or denies authorization for the request to be accepted by one or more database managers 207, 208 and 209.

Requests from manufacturers and suppliers are directed to the database manager 207, which has authority to perform read/write database actions upon the data stores located within the manufacturer/supplier database cluster 226.

Requests from merchants are directed to the database manager 208, which has authority to perform read/write database actions upon the data stores located within the merchant database cluster 227, and also to perform read-only database actions upon the data stores located within the manufacturer/supplier database cluster 226.

Requests for objects from within browsers are directed to the database manager 209, which has authority to perform read-only database actions upon the data stores located within the syndicated objects database cluster 228, and also to perform read-only database actions upon the images data store 220 and the association content data store 221 located within the merchant database cluster 227.

The results of actions performed, and/or information retrieved by the manufacturer/supplier database manager 207 is outputted through a content presentation engine 202, which prepares one of the following: 1) a graphical user interface with information organized in such as way as to be easily viewed by a human operator or 2) a structured query interface with information organized in such as way as to be easily consumed by a remote computer. After sufficient preparation of a suitable organization of information, the content presentation engine 202 outputs a response to the original request via the Internet 201, targeted to the originating computer.

The results of actions performed, and/or information retrieved by the merchant database manager 208 is outputted through a content presentation engine 203, which prepares one of the following: 1) a graphical user interface with information organized in such as way as to be easily viewed by a human operator or 2) a structured query interface with information organized in such as way as to be easily consumed by a remote computer. After sufficient preparation of a suitable organization of information, the content presentation engine 203 outputs a response to the original request via the Internet 201, targeted to the originating computer.

Information retrieved by the syndicated objects database manager 209 is outputted through a content presentation engine 204, which provides no further organization of information and passes on data substantially as stored in the syndicated objects data stores 223, 224 and 225; as well as the merchant data stores 220 and 221. The content presentation engine 203 outputs a response to the original request via the Internet 201, targeted to the originating computer.

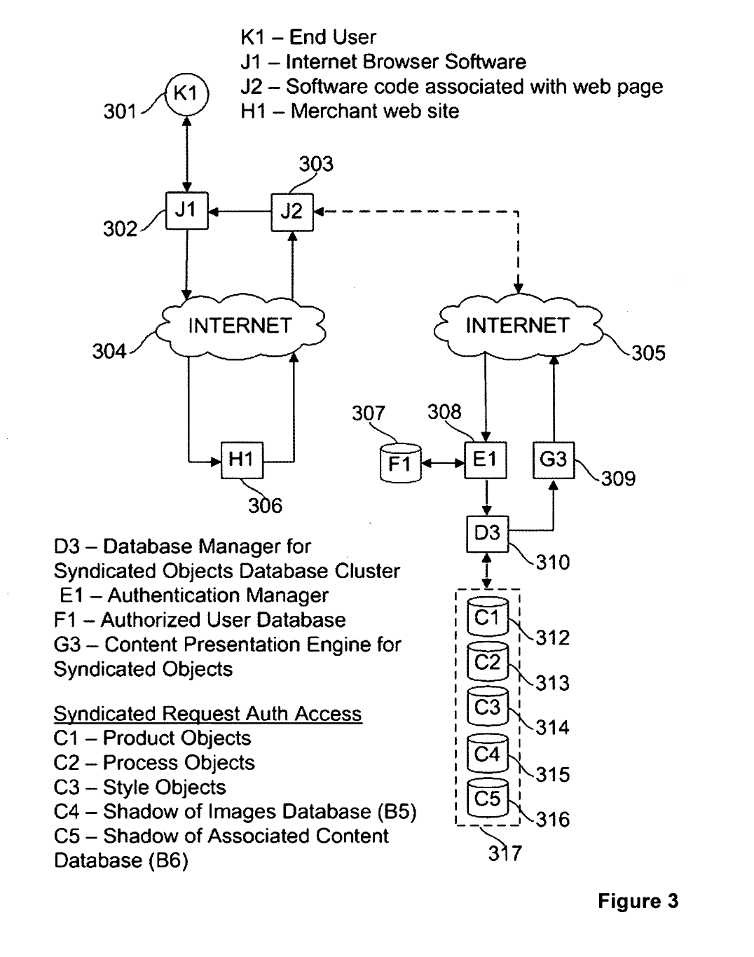

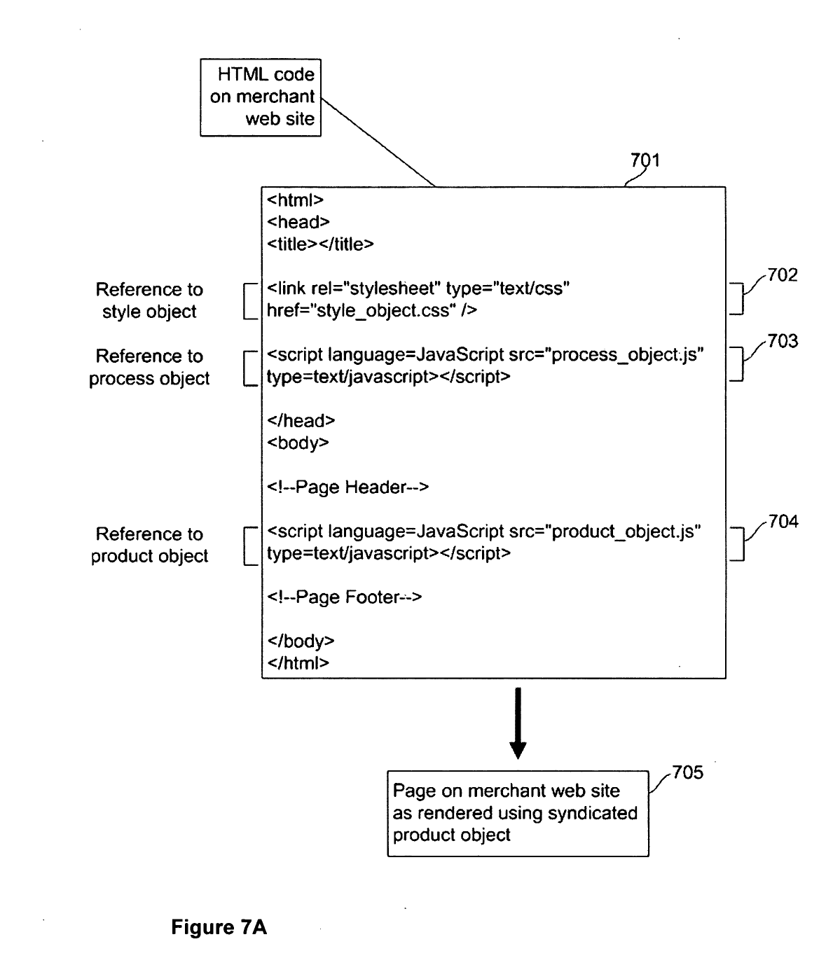

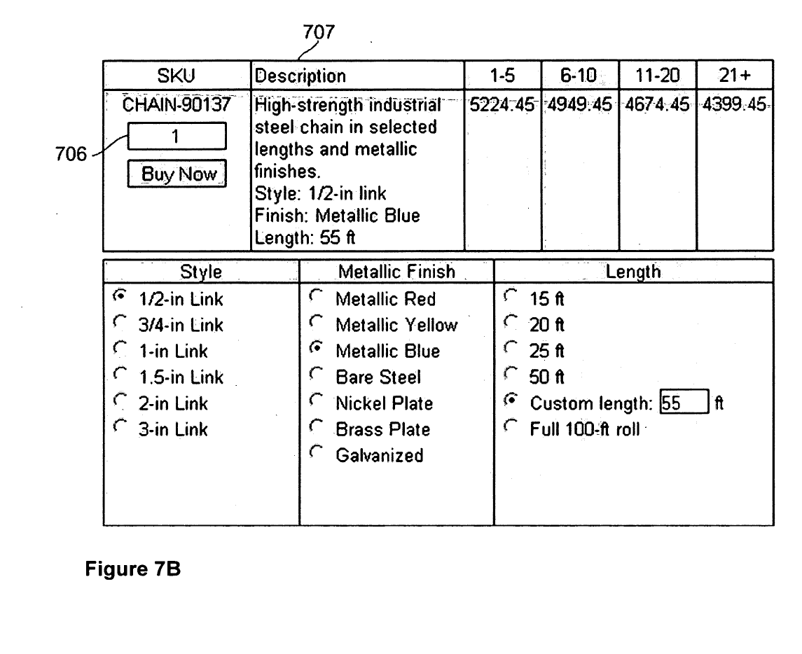

A schematic showing the retrieval of syndicated objects from the syndicated objects database cluster 228 is shown in FIG. 3. An end-user 301 using a browser 302 on an Internet-connect computer requests a web page from a merchant web site 306 located at a remote location, accessible via the Internet 304. The merchant web site returns to the browser the software code 303 used by the browser to render the web page. FIG. 7 is a representation of a typical web page 705 containing a syndicated product, showing the underlying code 701 and the syndicated product as rendered by a browser using the underlying code 701. Within the underlying code 701 are three references to objects stored within the syndicated object database cluster 228: a style object reference 702 pertaining to an object stored in the style objects data store 225; a process object reference 703 pertaining to an object stored in the process objects data store 224 and a product object reference 704 pertaining to an object stored in the product objects database store 223.

The product object reference 704 refers to a block of information that contains commands that, when executed, cause to be displayed on a web page a syndicated product, with accompanying descriptive information.

The style object reference 702 refers to a block of information that contains sufficient instructions pertaining to textual and graphic style characteristics such that the browser is able to render the underlying code contained within the product object as configured and intended by the merchant.

The process object reference 703 refers to a block of information that contains commands that, when executed by an event handler trigger, causes certain textual and graphical portions of the rendered syndicated product 705 to change, the purpose being to provide an intuitive interface for an end-user to select from a plurality of attributes contained within a plurality of variations, and to optionally manually configure certain such attributes by means of a text entry field.

Referring again to FIG. 3, a request for each syndicated object in the web page 303 is passed via the Internet to the central computer where each request is authenticated and, is accepted, is passed to the database manager 310, which has authority to perform read-only database actions upon the data stores 312, 313, 314, 315 and 316 located within the syndicated objects database cluster 317. After retrieval of the requested object, the database manager 310 passes it to the content presentation engine 309, which passes it substantially unchanged back to the requesting browser 302 via the Internet 305. Upon receipt of the product object, the browser executes the underlying code, causing to be rendered on the web page a visual representation of a product substantially as configured by the merchant, using style as contained within the style object. Dynamic functionality for the rendered product is provided by the underlying code within the process object, which is executable by an event handler trigger, which in a preferred embodiment is an end-user action such as clicking on a certain feature of the rendered product.

System Data Model

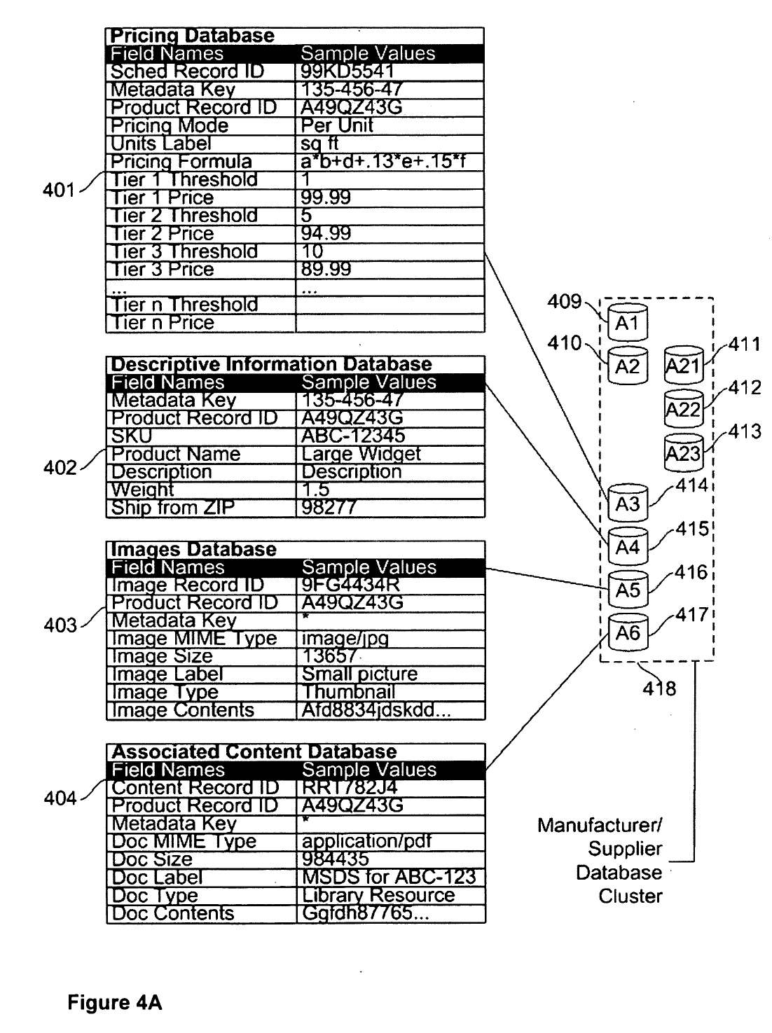

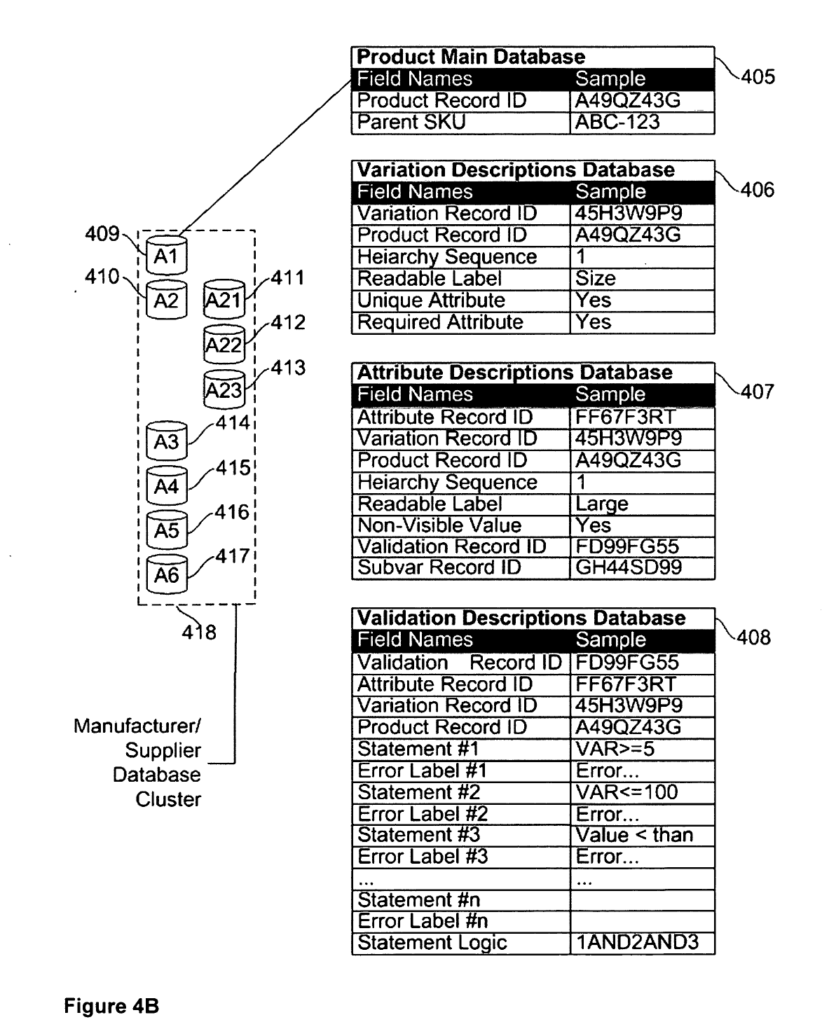

FIG. 4 is a representation of a preferred embodiment of the data model for the manufacturer/supplier database cluster 226 as referenced in FIG. 2. The database cluster 418 is composed of a plurality of data stores which, in the preferred embodiment, are as follows:

A product main data store 409 in which data is categorized or otherwise organized into addressable, retrievable locations based upon a data map 405 of field names to field values, specifically:
a field name entitled ‘PRODUCT RECORD ID’ with which a unique field value is associated, the field value consisting of an 8-character identifier composed of the characters 0-9 and A-Z; and
a field name entitled ‘PARENT SKU’ with which a unique field value is associated, the field value consisting of a variable-length combination of alphanumeric and non-alphanumeric characters sufficient to uniquely identify the class of product within the product syndication system.

A product variations data store 410 which, in the preferred embodiment, is divided up into three independently addressable data sub-stores 411, 412 and 413 described as follows:

A variation descriptions store 411 in which data is categorized or otherwise organized into addressable, retrievable locations based upon a data map 406 of field names to field values, specifically:
a field name entitled ‘VARIATION RECORD ID’ with which a unique field value is associated, the field value consisting of an 8-character identifier composed of the characters 0-9 and A-Z;
a field name entitled ‘PRODUCT RECORD ID’ with which a field value is associated corresponding to a record in the product main data store 409;
a field name entitled ‘HIEARCHY SEQUENCE’ with which a field value is associated corresponding to the order in which the variation appears in the overall hierarchy of variations;
a field name entitled ‘READABLE LABEL’ with which a field value is associated corresponding to a readable label describing the nature of the variation;
a field name entitled ‘UNIQUE ATTRIBUTE with which a field value of ‘TRUE’ or ‘FALSE’ is associated, indicating whether or not the variation can have one and only one attribute selected;
a field name entitled ‘REQUIRED ATTRIBUTE with which a field value of ‘TRUE’ or ‘FALSE’ is associated, indicating whether or not the variation must have at least one attribute selected; and
other field names as may be necessary or desired to describe variations associated with a parent product class;

An attribute descriptions store 412 in which data is categorized or otherwise organized into addressable, retrievable locations based upon a data map 407 of field names to field values, specifically:
a field name.entitled ‘ATTRIBUTE RECORD ID’ with which a unique field value is associated, the field value consisting of an 8-character identifier composed of the characters 0-9 and A-Z;
a field name entitled ‘VARIATION RECORD ID’ with which a unique field value is associated corresponding to a record in the variation descriptions main data store 411;
a field name entitled ‘PRODUCT RECORD ID’ with which a field value is associated corresponding to a record in the product main data store 409;
a field name entitled ‘HIEARCHY SEQUENCE’ with which a field value is associated corresponding to the order in which the attribute appears in the overall hierarchy of attributes associated with the variation referred to by ‘VARIATION RECORD ID’;
a field name entitled ‘READABLE LABEL’ with which a field value is associated corresponding to a readable label describing the nature of the attribute;
a field name entitled ‘NON-VISIBLE VALUE’ with which a field value is associated corresponding to a hidden value for the attribute;
a field name entitled ‘VALIDATION RECORD ID’ with which a field value is associated corresponding to a record in the validation descriptions data store 413 (described subsequently); and
a field name entitled ‘SUBVAR RECORD ID’ with which a field value is associated corresponding to a record in the variation descriptions data store 411 other than that referred to by ‘VARIATION RECORD ID’; and
other field names as may be necessary or desired to describe attributes associated with a specific variation of a parent product class;

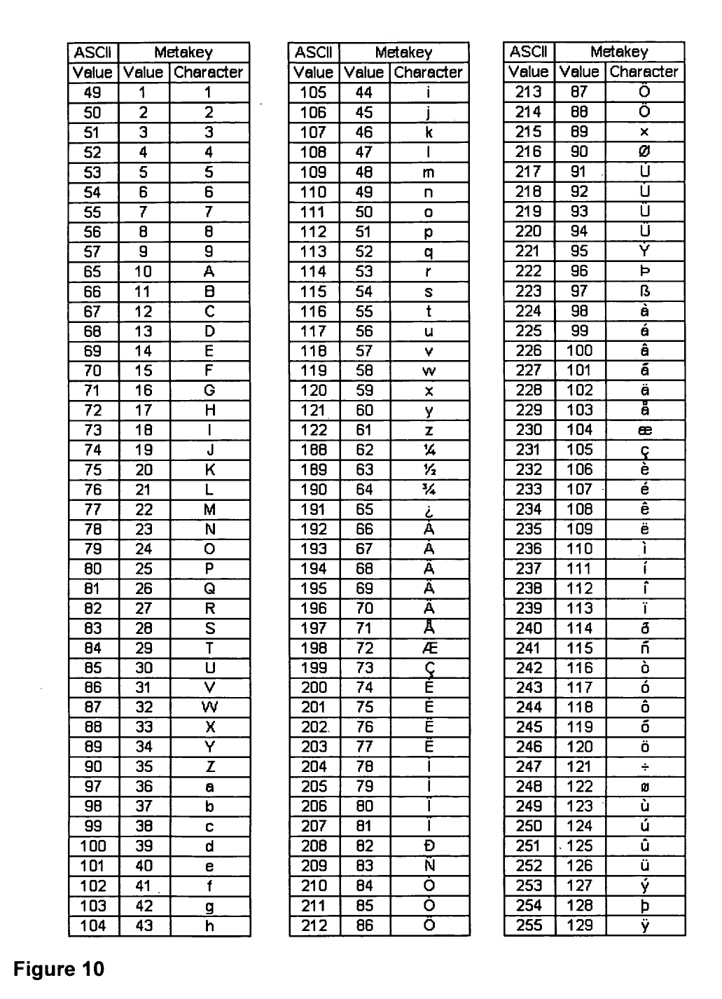

A validation descriptions store 413 in which data is categorized or otherwise organized into addressable, retrievable locations based upon a data map 408 of field names to field values, specifically:
a field name entitled ‘VALIDATION RECORD ID’ with which a unique field value is associated, the field value consisting of an 8-character identifier composed of the characters 0-9 and A-Z;
a field name entitled ‘ATTRIBUTE RECORD ID’ with which a unique field value is associated corresponding to a record in the attribute descriptions main data store 412;
a field name entitled ‘VARIATION RECORD ID’ with which a unique field value is associated corresponding to a record in the variation descriptions main data store 411;
a field name entitled ‘PRODUCT RECORD ID’ with which a field value is associated corresponding to a record in the product main data store 409;
a plurality of n field names entitled ‘STATEMENT 1’ through ‘STATEMENT n’, each of which are associated with a field value describing the method by which an end-user data entry shall be validated;
a plurality of n field names entitled ‘ERROR LABEL 1’ through ‘ERROR LABEL n’, each of which are associated with a field value describing why an end-user data entry failed validation method contained within its respective ‘ERROR_LABEL x’ field name; a field name entitled ‘STATEMENT LOGIC’ with which a field value is associated describing how statements contained within ‘STATEMENT 1’ through ‘STATEMENT n’ are to be collectively evaluated; and
other field names as may be necessary or desired to describe data entry validation methods associated with specific attributes of specific variations of a parent product class;
A pricing data store 414 in which data is categorized or otherwise organized into addressable, retrievable locations based upon a data map 401 of field names to field values, specifically:
a field name entitled ‘SCHEDULE RECORD ID’ with which a non-unique field value is associated, the field value consisting of an 8-character identifier composed of the characters 0-9 and A-Z;
a field name entitled ‘METAKEY’ with which a non-unique field value is associated, the field value consisting of a variable-length combination of characters from the metakey character column of the character map as shown in FIG. 10;
a field name entitled ‘PRODUCT RECORD ID’ with which a field value is associated corresponding to a record in the product main data store 409;
a field name entitled ‘PRICING MODE’ with which a field value either ‘per each’ or ‘per unit’ is associated;
a field name entitled ‘UNITS LABEL’ with which a field value describing the units by which the product pricing is calculated, if PRICING MODE is associated with a ‘per unit’ value;
a plurality of n field names entitled ‘TIER THRESHOLD 1’ through ‘TIER THRESHOLD n’, each of which are associated with a field value describing the qualifying quantity at which that particular tier's pricing will be effective;
a plurality of n field names entitled ‘TIER FIXED PRICE 1’ through ‘TIER FIXED PRICE n’, each of which are associated with a field value describing that particular tier's fixed price;
a plurality of n field names entitled ‘TIER VAR PRICE 1’ through ‘TIER VAR PRICE n’, each of which are associated with a field value describing that particular tier's variable price; and
other field names as may be necessary or desired to associate various pricing characteristics of a parent product class to specific combinations of variation attributes;

A descriptive information store 415 in which data is categorized or otherwise organized into addressable, retrievable locations based upon a data map 402 of field names to field values, specifically:
a field name entitled ‘METAKEY’, the associated value and format of which is substantially similar to the ‘METAKEY’ field described in the data map 401;
a field name.entitled ‘PRODUCT RECORD ID’, the associated value and format of which is substantially similar to the ‘PRODUCT RECORD ID’ field described in the data map 401;
a field name entitled ‘SKU’ with which a field value is associated that describes the commercial identifier by which this parent product class, with the specific combination of variation attributes described by METAKEY, is known;
a field name entitled ‘PRODUCT NAME’ with which a field value is associated that describes the commercial name or title by which this parent product class, with the specific combination of variation attributes described by METAKEY, is known;
a field name entitled ‘DESCRIPTION’ with which a field value is associated that describes the parent product class, as configured with the specific combination of variation attributes described by METAKEY;
a field name entitled ‘WEIGHT’ with which a field value is associated that describes the fixed or per unit weight, as configured with the specific combination of variation attributes described by METAKEY;
a field name entitled ‘SHIP FROM ZIP’ with which a field value is associated that describes the U.S. zip code of the location from which the the parent product class, as configured with the specific combination of variation attributes described by METAKEY, will be shipped to the end-user; and
other field names as may be necessary or desired to associate various descriptive elements of a parent product class to specific combinations of variation attributes;

An images information store 416 in which data is categorized or otherwise organized into addressable, retrievable locations based upon a data map 403 of field names to field values, specifically:
a field name entitled ‘IMAGE RECORD ID’ with which a unique field value is associated, the field value consisting of an 8-character identifier composed of the characters 0-9 and A-Z;
a field name entitled ‘PRODUCT RECORD ID’, the associated value and format of which is substantially similar to the ‘PRODUCT RECORD ID’ field described in the data map 401;
a field name entitled ‘METAKEY’, the associated value and format of which is substantially similar to the ‘METAKEY’ field described in the data map 401;
a field name entitled ‘IMAGE CONTENTS’, with which a field value is associated that contains the binary encoding of a digital image;
a field name entitled ‘IMAGE MIME TYPE’, with which a field value is associated that describes the MIME type of the image stored within the ‘IMAGE CONTENTS’ field;
a field name entitled ‘IMAGE SIZE, with which a field value is associated that describes the file size of the image stored within the ‘IMAGE CONTENTS’ field;
a field name entitled ‘IMAGE LABEL, with which a field value is associated that is a readable description of the image stored within the ‘IMAGE CONTENTS’ field;
a field name entitled ‘IMAGE TYPE, with which a field value is associated that describes the type of image stored within the ‘IMAGE CONTENTS’ field; and
other field names as may be necessary or desired to associate various images of a parent product class to specific combinations of variation attributes;

An associated content information store 417 in which data is categorized or otherwise organized into addressable, retrievable locations based upon a data map 404 of field names to field values, specifically:
a field name entitled ‘CONTENT RECORD ID’ with which a unique field value is associated, the field value consisting of an 8-character identifier composed of the characters 0-9 and A-Z;
a field name entitled ‘PRODUCT RECORD ID’, the associated value and format of which is substantially similar to the ‘PRODUCT RECORD ID’ field described in the data map 401;
a field name entitled ‘METAKEY’, the associated value and format of which is substantially similar to the ‘METAKEY’ field described in the data map 401;
a field name entitled ‘DOC CONTENTS’, with which a field value is associated that contains the binary encoding of a digitally encoded document;
a field name entitled ‘DOC MIME TYPE’, with which a field value is associated that describes the MIME type of the digitally encoded document stored within the ‘DOC CONTENTS’ field;
a field name entitled ‘DOC SIZE, with which a field value is associated that describes the file size of the digitally encoded document stored within the ‘DOC CONTENTS’ field;
a field name entitled ‘DOC LABEL, with which a field value is associated that is a readable description of the digitally encoded document stored within the ‘DOC CONTENTS’ field;
a field name entitled ‘DOC TYPE, with which a field value is associated that describes the type of document stored within the ‘DOC CONTENTS’ field; and
other field names as may be necessary or desired to associate various associated content of a parent product class to specific combinations of variation attributes;

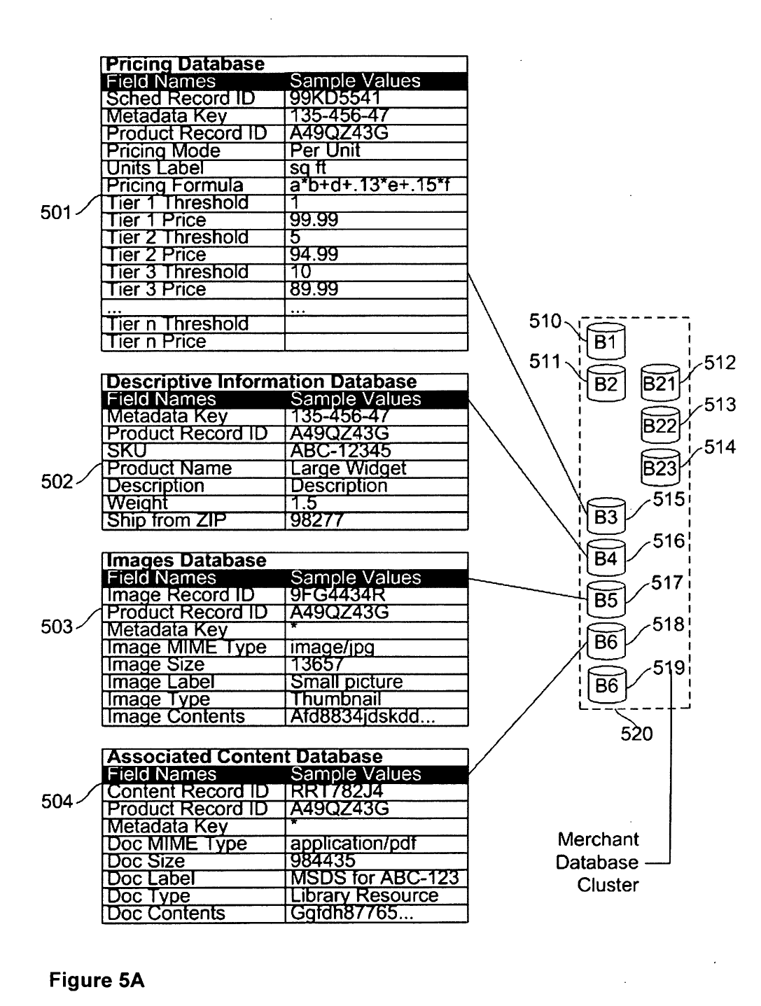

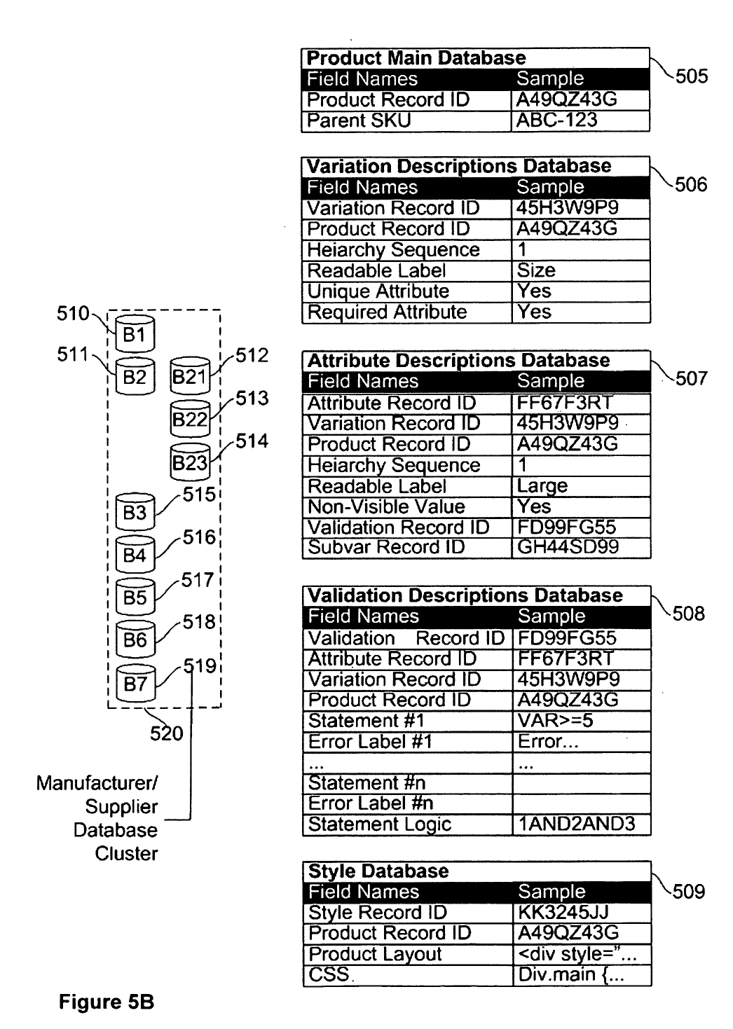

FIG. 5 is a representation of a preferred embodiment of the data model for the merchant database cluster 227 as referenced in FIG. 2. The database cluster 520 is composed of a plurality of data stores substantially identical in composition to the manufacturer/supplier database cluster 226 as previously described, with the exception of an additional data store as follows:

A style data store 519 in which data is categorized or otherwise organized into addressable, retrievable locations based upon a data map 404 of field names to field values, specifically:
a field name entitled ‘STYLE RECORD ID’ with which a unique field value is associated, the field value consisting of an 8-character identifier composed of the characters 0-9 and A-Z;
a field name entitled ‘PRODUCT RECORD ID’, the associated value and format of which is substantially similar to the ‘PRODUCT RECORD ID’ field described in the data map 401;
a field name entitled ‘PRODUCT LAYOUT’, with which a field value is associated that describes the software code used by a web browser to render the structural elements of a syndicated product object;
a field name entitled ‘CSS’, with which a field value is associated that contains CSS-encoded style statements used by the browser to render certain display-based characteristics of the aforementioned syndicated product object; and
other field names as may be necessary or desired to associate various associated content of a parent product class to specific combinations of variation attributes;

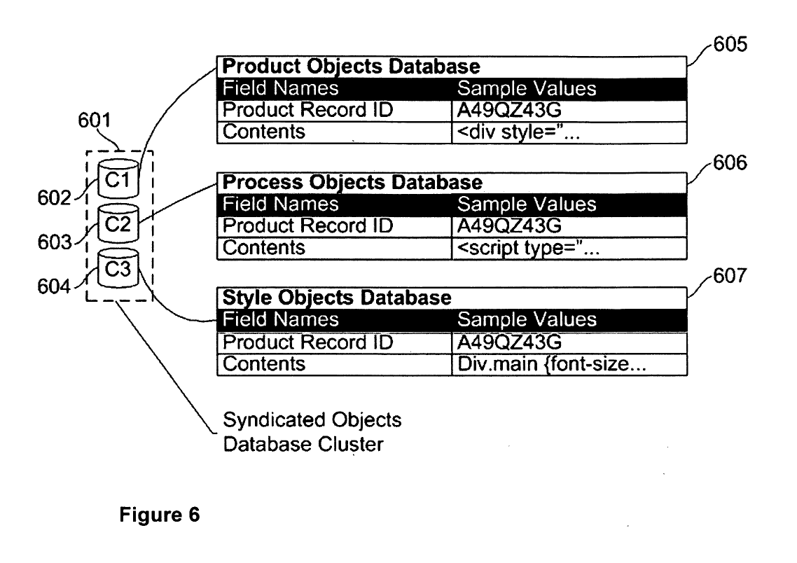

FIG. 6 is a representation of a preferred embodiment of the data model for the syndicated objects database cluster 228 as referenced in FIG. 2. The database cluster 601 is composed of a plurality of data stores which, in the preferred embodiment, are described as follows:

A product objects data store 602 in which data is categorized or otherwise organized into addressable, retrievable locations based upon a data map 605 of field names to field values, specifically:
a field name entitled ‘PRODUCT RECORD ID’, the associated value and format of which is substantially similar to the ‘PRODUCT RECORD ID’ field described in the data map 401;
a field name entitled ‘CONTENTS, with which a field value is associated that contains executable software code used by a web browser to render the structural components of a syndicated product object; and
other field names as may be necessary or desired to associate various associated content of a parent product class to specific combinations of variation attributes;

A process objects data store 603 in which data is categorized or otherwise organized into addressable, retrievable locations based upon a data map 606 of field names to field values, specifically:
a field name entitled ‘PRODUCT RECORD ID’, the associated value and format of which is substantially similar to the ‘PRODUCT RECORD ID’ field described in the data map 401;
a field name entitled ‘CONTENTS, with which a field value is associated that contains executable software code used by a web browser to bind end-user dynamic functionality with the aforementioned syndicated product object; and
other field names as may be necessary or desired to associate various associated content of a parent product class to specific combinations of variation attributes;

A style objects data store 604 in which data is categorized or otherwise organized into addressable, retrievable locations based upon a data map 607 of field names to field values, specifically:
a field name entitled ‘PRODUCT RECORD ID’, the associated value and format of which is substantially similar to the ‘PRODUCT RECORD ID’ field described in the data map 401;
a field name entitled ‘CONTENTS, with which a field value is associated that contains software code used by a web browser to render certain display-related characteristics of the aforementioned syndicated product object; and
other field names as may be necessary or desired to associate various associated content of a parent product class to specific combinations of variation attributes;

The representation of the syndicated objects database cluster 317 as shown in FIG. 3 shows two other data stores in addition to the three described above. These are actually ‘shadows’ of the merchant data stores 220 and 221 shown in FIG. 2, and are not physically distinct data stores. In the preferred embodiment, end-user requests for images and associated content will be passed to the syndicated objects database cluster 228, which will retrieve the requested items in read-only mode from data stores 220 or 221, appropriately.

In the preferred embodiment, each parent class of product has a single record within the product main data store 405; but one or more child records that describe variations of that parent class of product may appear within the pricing data store 401, the descriptive information data store 402, the images data store 403 and the associated content data store 404. Because manufacturers and suppliers may desire to configure unique pricing, descriptive data, images and associated content to one or more merchants who subsequently configure such product information to be deployed as syndicated objects, each record within the aforementioned data stores is assigned a SCHEDULE RECORD ID, which is associated to one or more merchants. In this manner, manufacturers and suppliers can configure multiple, parallel sets of pricing and descriptive information, each tailored to one or more merchants, and accessible only by merchants to whom said SCHEDULE RECORD ID has been associated.

In the preferred embodiment, the set of values for SCHEDULE RECORD ID that exist in the data stores 401, 402, 403 and 404 are not necessarily identical for each parent class of product. For a specific parent class of product, for example, there may be 5 different values for SCHEDULE RECORD ID in all of the records within the pricing data store 401, shared by 50 different merchants; but there may be only 2 different values for SCHEDULE RECORD ID in all of the records within the images data store 403, shared by the same 50 merchants; and only a single value of SCHEDULE RECORD ID in all of the records within the associated content data store 404, shared by the same 50 merchants. A SCHEDULE RECORD ID refers to a record that describes a group of one or more merchants; it may be associated with every merchant authorized to use the product syndication system, or to a single merchant. A SCHEDULE RECORD ID can also refer to a null record describing zero merchants, effectively causing that record to be unobtainable by merchants.

The field value associated within the METAKEY field name within each of the data stores 401, 402, 403 and 404 is a non-unique string of characters that self-describe a specific combination of variation attributes for a specific parent class of product. FIG. 10 shows a character map used to create values for metakeys in the preferred embodiment, in which a subset of characters from the ASCII character set are assigned new values ranging from 1 to 128. The metakey is derived by adding, from left to right, the sequential number of a selectable variation attribute within each variation. Each character in the metakey pertains to a variation level, such that the first character pertains to the first variation, and its value pertains to the sequential number of a selectable variation attribute within the hierarchy of all attributes within that variation.

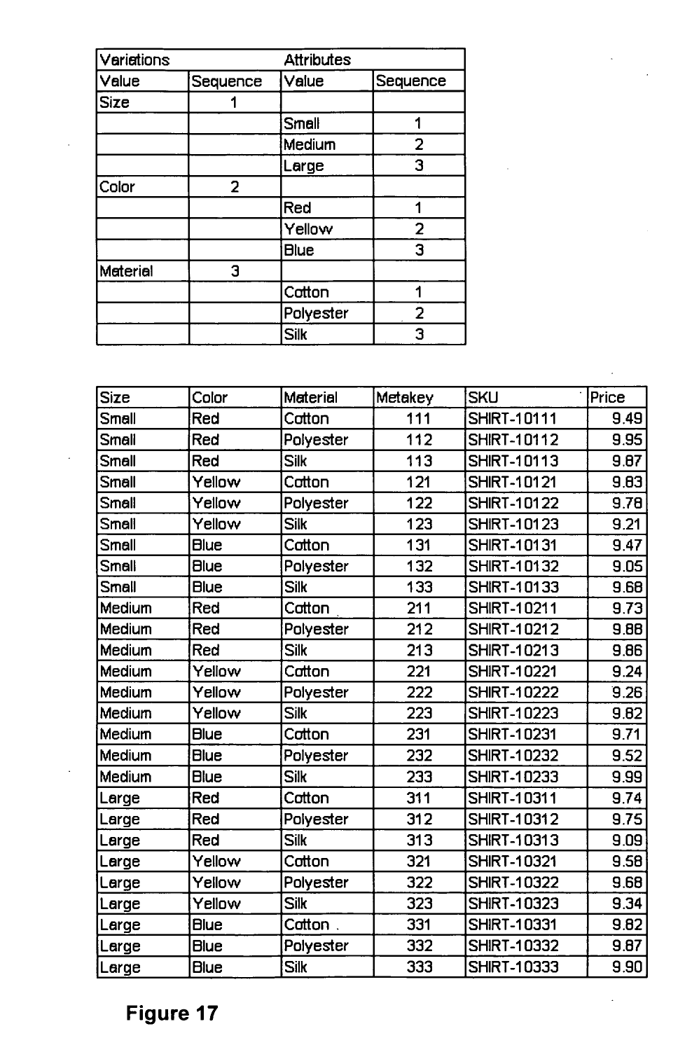

FIG. 17 shows a representation of a product with three variations: size, color and material; and the resulting combinations of all variation attributes allowable. Each combination of variation attributes is assigned a metakey unique to the parent product class, which is then used to reference pricing and descriptive data for that specific combination of variation attributes. For example, the selection of a large, red, silk shirt is identified by the metakey 313, which is associated with the SKU SHIRT-10313 and the price 9.09.

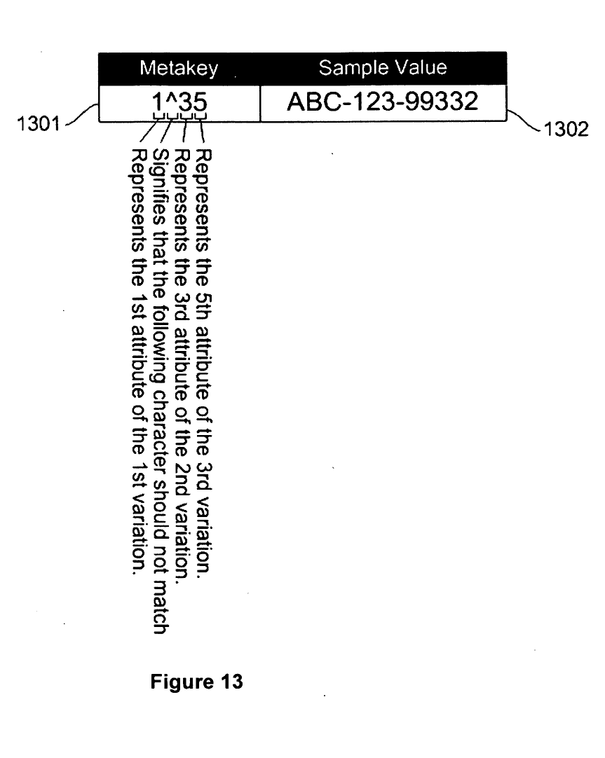

FIG. 13 shows a representation of a sample value for the metakey, in which a selectable combination of variation attributes is represented by the value ‘135’, associating the 1^{st} attribute of the 1^{st} variation, the 3^{rd} attribute of the second variation, and the 5^{th} attribute of the third variation. This metakey value, when associated with a unique PRODUCT RECORD ID, allows the manufacturer/supplier to associate unique records for pricing, descriptive data, images and associated content with a specific combination of selectable variation attributes.

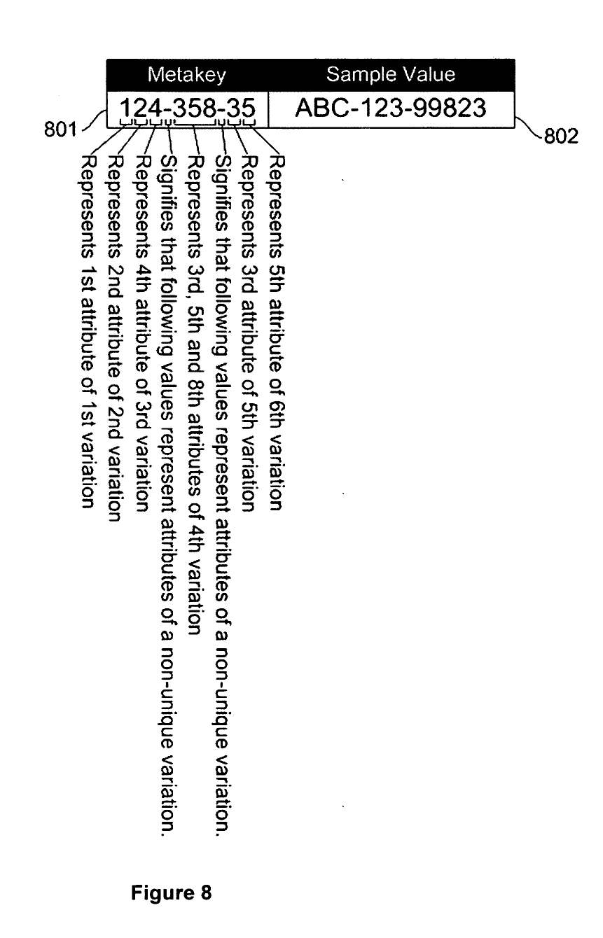

The structure of the metakey is variable to accommodate certain instances in which a variation does not have a uniquely selectable attribute, as is the case with variations in which more than one attribute can be selected. In the preferred embodiment, the character for a non-unique variation is replaced by opening and closing dashes ‘-’, between which appear potentially selectable variation attributes. FIG. 8 shows a metakey 801 describing a combination of variation attributes from five variation levels, the fourth of which is non-unique, and consists of three simultaneously selected variation attributes 3, 5 and 8 contained between opening and closing dashes. The metakey in this case is associated to a SKU 802.

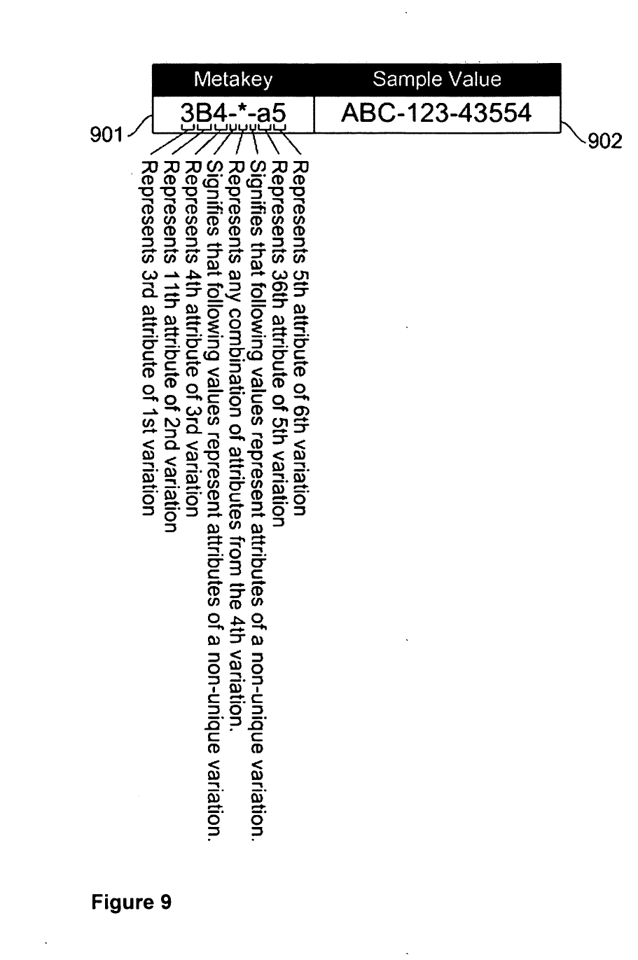

In some instances, the value of a selectable variation attribute does not dictate the value to be associated with a specific combination of variation attributes. The metakey allows a ‘*’ to be used as a ‘wild card’, extending the number of possible combinations of variation attributes that can share the same metakey. FIG. 9 shows a metakey 901 describing a combination of variation attributes from six variation levels, the fourth of which is non-unique, but contains a ‘*’ between the opening and closing dashes. This indicates that any combination of attributes, including zero, from the fourth variation level will match against this metakey, assuming all other unique variation attributes in the metakey are selected. The metakey in this case is associated to a SKU 902. The ‘*’ ‘wild card’ can also be used to replace a unique variation attribute, such that any selected attribute for that variation will share the same metakey.

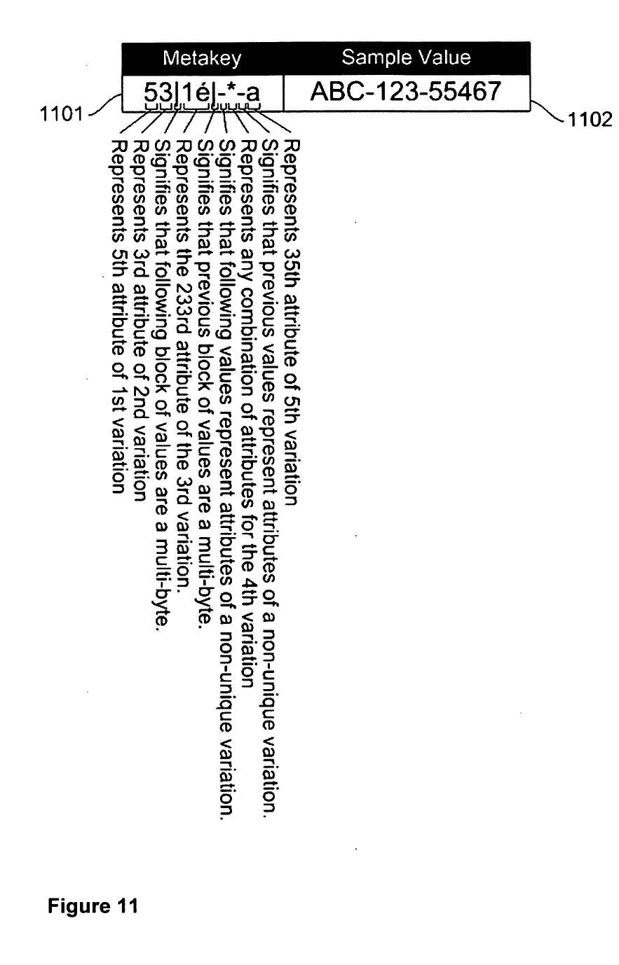

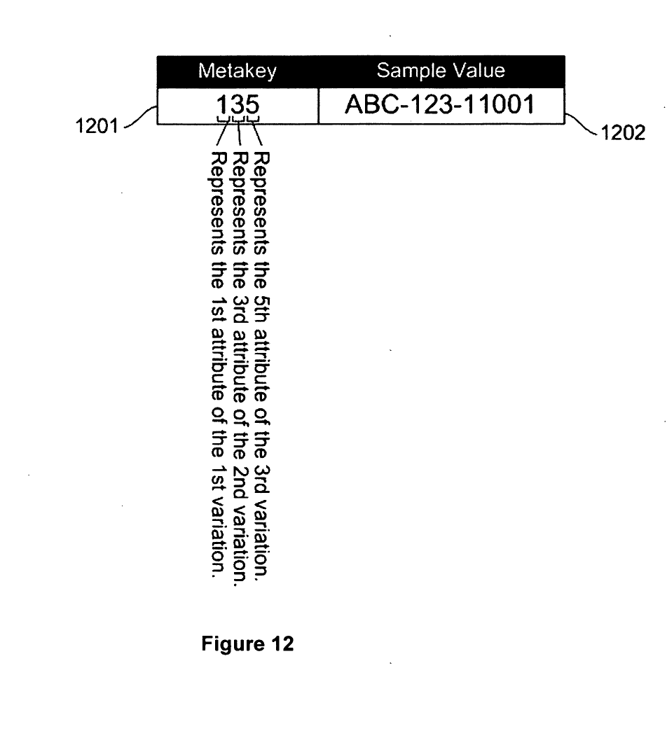

In the preferred embodiment, the metakey is derived from characters in a custom character map as shown in FIG. 10, allowing each character within the metakey to pertain to a value of 1 to 128, which corresponds to the sequence number in which a selectable variation attribute appears in the entire group of variation attributes for any one variation. Because a value greater than 128 cannot be conveyed by a character from the character map, if a variation has more than 128 attributes, the metakey can accommodate a ‘multi-byte’ value, made up of two or more characters from the character map. This is accomplished by replaced a single character by an opening and closing ‘pipe’ [|], between which appears two or more characters. These characters represent a value in base-128 notation in which the first character at right contains a value between 1 and 128, the second character from the right represents a value between 128 and 16384, in steps of 128, and so on. The result is that by using multi-byte values when necessary, any number of variations can be represented. Such multi-byte values can be used to replace unique variation attributes within the metakey, or non-unique attributes contained within opening and closing dashes. FIG. 11 shows an example of a metakey 1101 that contains a multi-byte value of ‘1é’ to represent the 235^{th} attribute of the third variation. The metakey in this case is associated to a SKU 1102.

There may instances in a preferred embodiment when it is desired to associate a combination of variation attributes to other information based on what is not selected, rather than what is selected. The metakey provides this functionality through use of the carat character ‘̂’, which signifies that the character immediately following the carat is to be negatively matched. FIG. 13 shows an example of a metakey 1301 in which a carat is placed in front of the ‘3’ in the second variation, signifying that all second variation attributes except the third attribute are associated to this metakey, assuming that the first variation attribute is 1, and the third variation attribute is 5. The metakey in this case is associated to a SKU 1302.

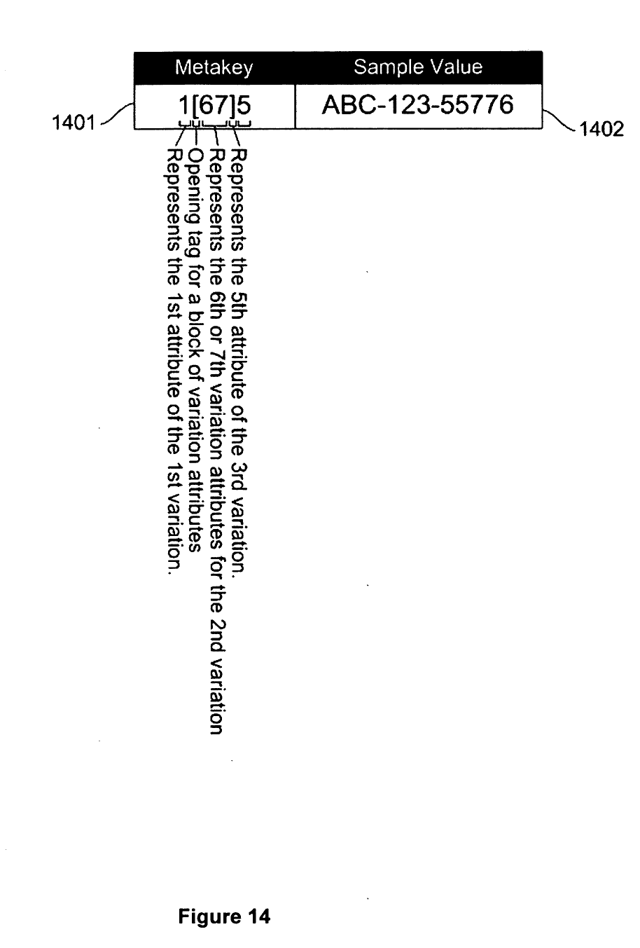

There may instances in a preferred embodiment when it is necessary to associate a list of possible variation attributes to qualify or disqualify association to a specific metakey. Such lists can be contained within opening and closing brackets ‘[’ and ‘]’, signifying that any value within the list satisfies the match or non-match for that variation level. FIG. 14 shows an example of a metakey 1401 in which opening and closing brackets are placed around the two variation attributes in the second variation, indicating that either attribute is associated with this metakey. The metakey in this case is associated to a SKU 1402.

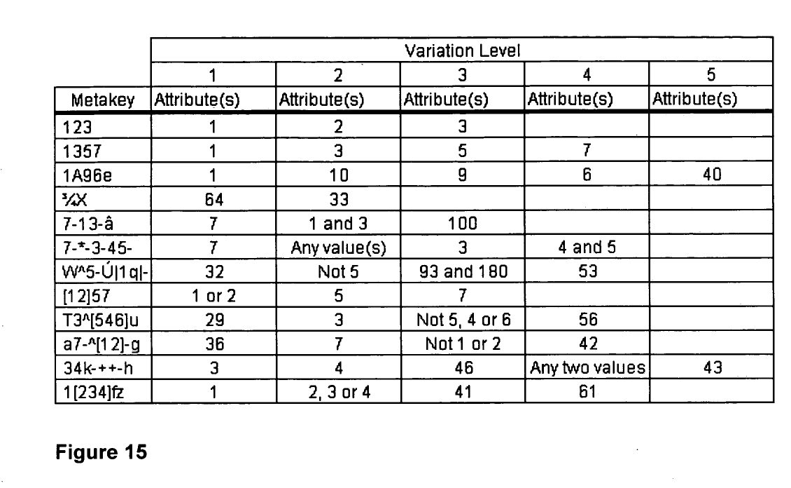

Referring to FIG. 15, a sample of valid metakeys derived from the character map, special characters and procedures of a preferred embodiment as described previously is shown in the leftmost column. The interpolated value of each character or block of characters associated with each variation level is shown in the columns extending to the right, associated with variation levels 1 through 5. As can be seen, the metakey data model, with its flexible structure, character map, and functional operators, provides for a great deal of flexibility in associating specific combinations of variation attributes to pricing data, descriptive information, images and associated content.

Referring to FIG. 4, in the preferred embodiment, each record in the pricing data store 401 can have associated with it one or more fixed prices, as contained within the group of field names in the format ‘TIER FIXED PRICE 1’ through ‘TIER FIXED PRICE n’, and one or more variable prices, as contained within the group of field names in the format ‘TIER VAR PRICE 1’ through ‘TIER VAR PRICE n’. A fixed price is associated with a value of ‘per each’ in the PRICING MODE field name, and consists of a number, either integer or decimal, representing a fixed price for the specific combination of variation attributes described by the metakey for that parent product class. A variable price is associated with a value of ‘per unit’ in the PRICING MODE field name, and consists of a statement that is understood by the product syndication system as a formula by which to calculate variable per unit pricing. A valid statement consists of a the numbers 0-9, the characters a-z, the mathematical operators ‘+’,‘−’,‘×’ and ‘+’, the decimal ‘.’, opening and closing parenthesis ‘(‘and ‘)’, and the exponent operator ‘̂. The manufacturer/supplier can create variable pricing for each combination of variation attributes by entering a statement into the associated record within the pricing data store 401. The statement is executed internally by various subroutines on the syndicated product system for the purposes of displaying pricing information to manufacturers and supplier, merchants and for the creation of syndicated objects to be stored in the syndicated objects database cluster 228 in FIG. 2. Partial statements contained within opening and closing parenthesis are executed first, working outwards from the innermost nested parenthesis, if present in the statement. The characters a-z are used to refer to values of one or more sub-variation attributes, which in a preferred embodiment consist of one or more manual inputs from the customer to be applied to ‘per unit’ pricing. The letter ‘a’ refers to the first variation, the letter ‘b’ refers to the second variation, and so on. Furthermore, because a selected variation attribute may have multiple sub-variations associated with it, the second character in the sub-variation attribute reference refers to the sequence in which the sub-variation attribute appears. Thus, ‘aa’ refers to the value of the first sub-variation attribute in the first variation; ‘ab’ refers to the value of the second sub-variation attribute in the first variation; and so on.

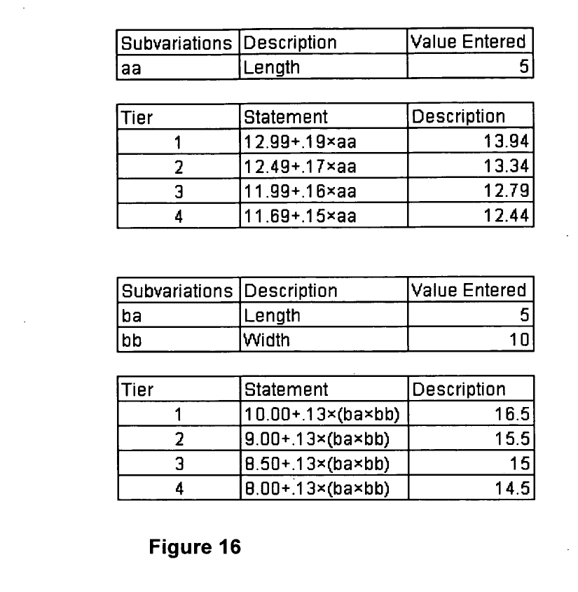

FIG. 16 shows two examples of a set of variable pricing records, the first of which relates to a syndicated product in which the attribute selected in the first variation includes a sub-variation attribute that solicits the entry of a length from the end-user. That value, referenced as ‘aa’ in the variable pricing statement, is used to calculate variable ‘per unit’ pricing for each of a plurality of pricing tiers. The second example relates to a syndicated product in which the attribute selected in the second variation include two sub-variation attributes that solicit the entry of a length and width from the end-user. These values, references as ‘ba’ and ‘bb’ respectively, are used to calculate variable ‘per unit’ pricing for each of a plurality of pricing tiers.

System Functionality

In the preferred embodiment, one or more manufacturers and suppliers are granted access to the product syndication system, and use a combination of manual and automated processes to cause to be recorded into the manufacturer/supplier database cluster a certain number of records pertaining to a plurality of parent product classes. As shown in FIG. 1, a web interface 104 is provided to manufacturers and suppliers allowing them to 1) manage products using a human-readable graphical user interface or 2) integrate one or more third-party information storage and retrieval systems to the product syndication using the machine-readable structured query interface.

In the preferred embodiment, manufacturers and suppliers are granted access to the product syndication system via a subscription service, which provides them with the capability of creating a certain number of parent product classes. Merchants are also granted access to the product syndication system via a subscription service, which may be partially subsidized by manufacturers or suppliers with whom they are affiliated. The terms of a merchant subscription allow them to create a certain number of product parent classes, either by copying an existing record from the manufacturing and supplier database cluster, or creating it themselves. They also are allotted a certain bandwidth per subscription term, such that merchants who cause a high volume of object requests to occur will be charged a proportionally higher amount than merchants with lower volume.

Manufacturers and suppliers assign read-only rights for selected products to one or more merchants, and assign pricing and other descriptive elements, if desired, through the configuration of specific schedule records. The end result is that merchants are able to browse and select only products to which the manufacturer/supplier has granted them access. Furthermore, pricing and descriptive information may be different for each merchant, or for groups of merchants, if the manufacturer/supplier has associated schedule records with certain products.

Merchants are able to access the product syndication system using a web interface 106 as shown in FIG. 1, which provides the same human-readable and machine-readable functionality as does the web interface for the manufacturers and suppliers previously described. In the preferred embodiment, merchants select products they wish to sell, causing to be copied all product records from the manufacturer/supplier database cluster 226 as shown in FIG. 2, to the merchant database cluster 227. Once copied, the merchant further refines the product records, at the very least modifying pricing and SKU's. Merchants are provided with a suite of styles from which to choose, and the ability to apply said styles to parent product classes. Merchants can also create and store their own styles to be associated with one or more parent product classes.

After the merchant has refined each product record to their satisfaction, they publish the entire record as a series of objects, stored in the syndicated objects database 228 in FIG. 2. The creation of syndicated objects is accomplished by a software system integral to the product syndication system, which retrieves all records associated with a parent product class, builds an association of all variation attributes, and creates process code that will allow a remote user to interface with all possible combinations of variation attributions within a single page-view, with no further web server interaction necessary. The objects can be written in a variety of different software languages. In the preferred embodiment, the style objects are written in a format known as Cascading Style Sheets (CSS); the process objects are written in Javascript; and the product object is written in either Flash or in Javascript that, when executed, creates HTML code.

After each product has been saved as a series of syndicated objects, the merchant is provided with one or more small ‘snippets’ of code intended to be inserted into an appropriate location on a web page. When the web page is requested by an end user, the code snippets are read and executed, causing to be requested and delivered the syndicated product objects necessary to render the product on the web page.

The code snippets include authentication information that binds the request for objects to a specific merchant and alternatively, to a specific domain. If the code snippet is published on an unauthorized web page, the product syndication system will reject the object request. Similarly, if the merchant's access to the product syndication system is revoked, the system will reject the object request.

In an alternative embodiment of the invention, certain hidden form elements within the rendered product are intended for use by the resident E-Commerce system, and provide a means for the syndicated product to be recognized by third-party E-Commerce software. In such an embodiment, the merchant is able to configure custom form element names for the visible quantity field XXX as shown in FIG. 7, the visible ‘add to cart’ button, and hidden form elements containing SKU, description and pricing information. In this manner, the product is able to be recognized by third-party E-Commerce software, and products rendered as a result of product syndication can be purchased on a merchant web site no differently than products rendered through conventional means.

In an alternate embodiment of the invention, certain elements of a plurality of parent product classes are combined to create a single product object, with accompanying style and process objects, such that the end-user can interface with a single object to select and/or configure various variation attributes. In this alternate embodiment, metakeys for all constituent products are derived within the underlying code, and presented for use by other portions of the underlying code, and alternatively delivered back to the product syndication system. In this manner, merchants can create clusters of products that are presented to customers as a single product, but when purchased, are identifiable by the merchant as separate constituent products.

In an alternate embodiment of the invention, data entry by end-users is facilitated by dynamic data entry objects that respond to the movement of a manual pointing device such as a mouse, and/or a series of one or more keyboard actions. In one version of the alternate embodiment, the dynamic data entry object responds to lateral movements of a mouse, either left/right or up/down, causing to be calculated and entered into one or more elements within the web page, values that adhere to the validation statements as configured by the merchant for the specific variation attribute. In another version of the alternate embodiment, the dynamic data entry object responds to rotational movements of one of several rotational controls on the mouse, when the mouse cursor is placed over the object, causing to be calculated and entered into one or more elements within the web page, values that adhere to the validation statements as configured by the merchant for the specific variation attribute.

In an alternate embodiment of the invention, end-user actions on the product objects rendered within a browser are continuously captured by software embedded within the process object and presented to one or more elements within the web page; and are alternatively sent back to the product syndication where such actions are recorded with user-specific information associated with them. In this manner, the end-user's shopping activities can be known and tracked remotely by the product syndication server, to the degree that a conventional E-Commerce ‘shopping cart’ system need not be resident on the merchant web server, but provided as a matter of course by the product syndication server. In similar fashion, all ancillary functions needed to facilitate an E-Commerce transaction are delivered to the end-user browser as objects, with the user never leaving the merchant site; to include: web-based query forms to collect and validate billing and shipping information, forms to collect and validate payment information, and forms to provide searchabilty of products on the merchant web site, searching instead product objects located within the syndicated objects database cluster and delivering search results as an embedded object directly to the end-user browser.

FIG. 7 is a component-level view of an HTML document 701 that contains a series of syndicated objects 702, 703 and 704 that, when rendered by a web browser, causes to be displayed a web page 705 with an embedded product object whose variation attributes can be configured by the end-user with no further interaction with the web server.

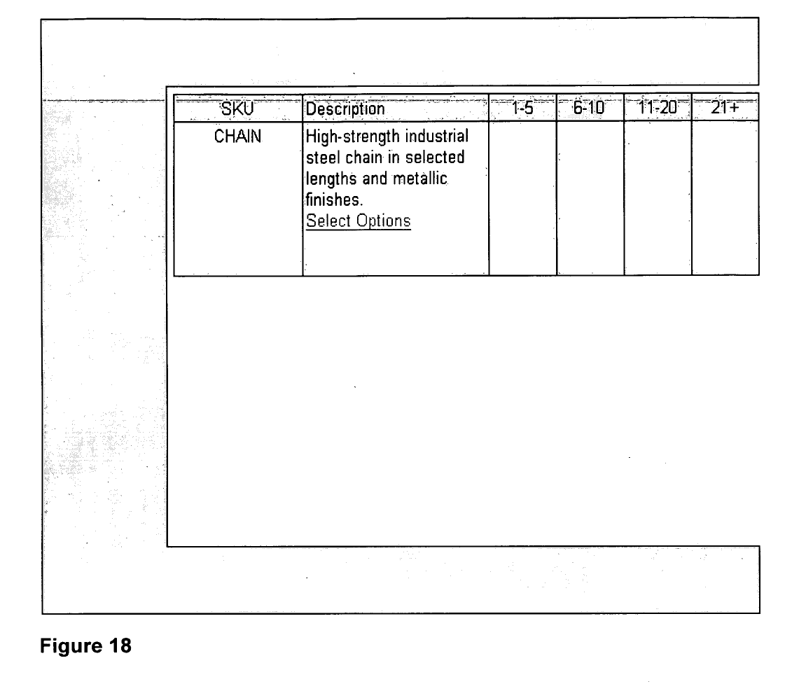

FIGS. 18 through 27 show a typical sequence of displays that an end user might see while interacting with the syndicated product object described above. FIGS. 18 through 27 were rendered by executable software code as listed in EXAMPLES 1a, 1b, 1c, 1d and 1e.

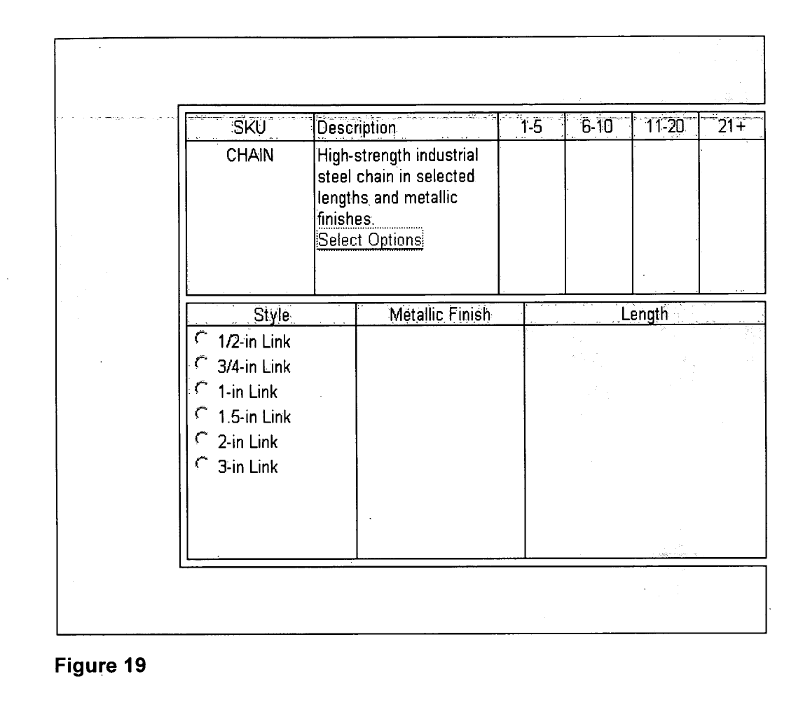

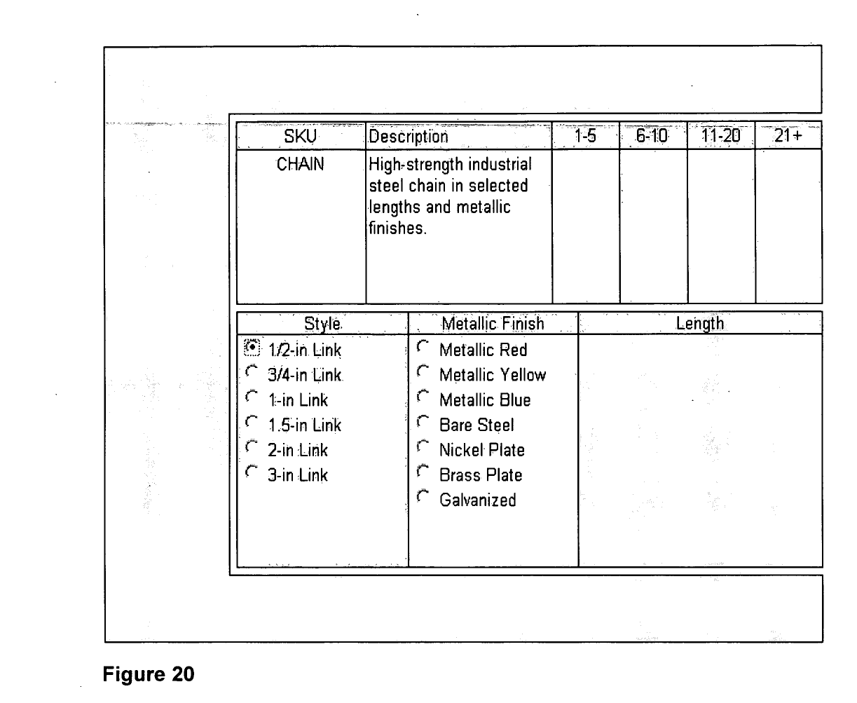

FIG. 18 shows the body of a syndicated object with no pricing nor variations visible. The end user is unable to add this product to his cart of otherwise proceed with any sort of transaction because all form elements capable of interacting with the web server are hidden from view. By clicking on the ‘Select Options’ link, an embedded function is executed within the web page, causing to be revealed a previously hidden section containing variations and variation attributes. FIG. 19 shows the first of three variation levels associated with the product, ‘Style’, ‘Metallic Finish’ and ‘Length’, with only the variation attributes in the ‘Style’ variation revealed. Each section of the syndicated product is color-coded, to convey to the user which sections of the product have been acceptably configured, which are not yet configured, and which are not yet visible. FIG. 19 shows a typical color encoding scheme used in the preferred embodiment, in which non-visible portions are gray, visible but un-configured portions are yellow, and visible and configured portions are green. The body of the syndicated object is rendered with a yellow background, indicating that it is visible but not yet fully configured. As the end user selects the first attribute, ‘½-in Link’, in the ‘Style’ variation, allowable attributes in the ‘Metallic Finish’ variation are revealed as shown in FIG. 20. The background color of the ‘Style’ variation is switched from yellow to green, indicating that it has been successful configured. The background color of the ‘Metallic Finish’ variation is switched from gray to yellow, indicating that it is visible but un-configured. Only metallic finishes available in the ‘112-in Link’ style are shown; all others are hidden from view, making it impossible for the end user to select a combination of variation attributes that is not available.

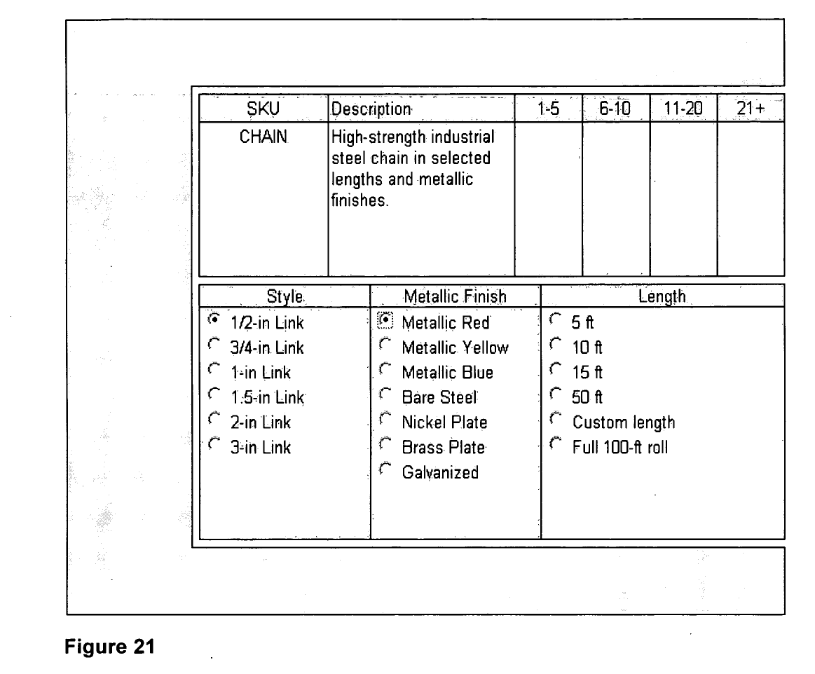

The end user then selects ‘Metallic Red’ in the ‘Metallic Finish’ variation as shown in FIG. 21, revealing allowable attributes in the ‘Length’ variation. The background color of the ‘Metallic Finish’ variation is switched from yellow to green, indicating that it is successfully configured. The background color of the ‘Length’ variation is switched from gray to yellow, indicating that it is visible but un-configured.

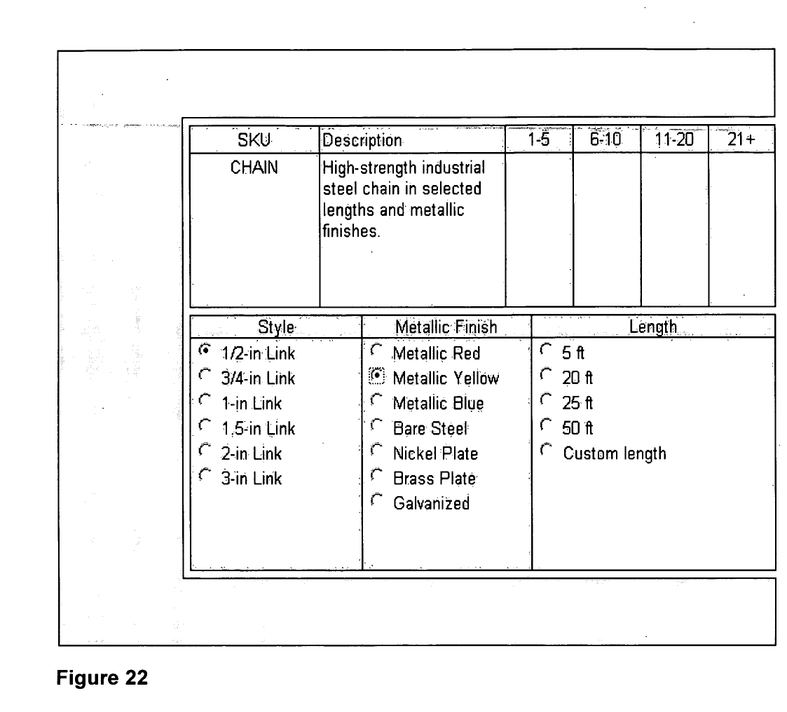

The end user then selects ‘Metallic Yellow’ in the ‘Metallic Finish’ variation as shown in FIG. 22, revealing a different set of allowable attributes in the ‘Length’ variation. The background color of the ‘Metallic Finish’ variation remains green, indicating that it is still successfully configured. The background color of the ‘Length; variation remains yellow, indicating that it is still visible but un-configured.

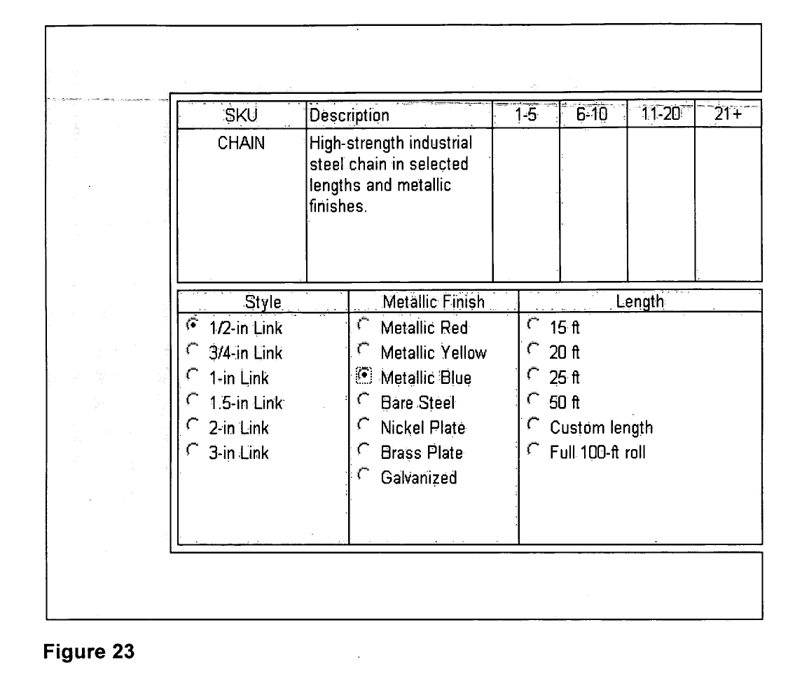

The end user then selects ‘Metallic Blue’ in the ‘Metallic Finish’ variation as shown in FIG. 23, revealing a different set of allowable attributes in the ‘Length’ variation. The background color of the ‘Metallic Finish’ variation remains green, indicating that it is still successfully configured. The background color of the ‘Length; variation remains yellow, indicating that it is still visible but un-configured.

Note that the ‘Length’ attributes shown in FIG. 21, 22 and 23 are different, because each ‘Metallic Finish’ attribute is associated with different ‘Length’ attributes.

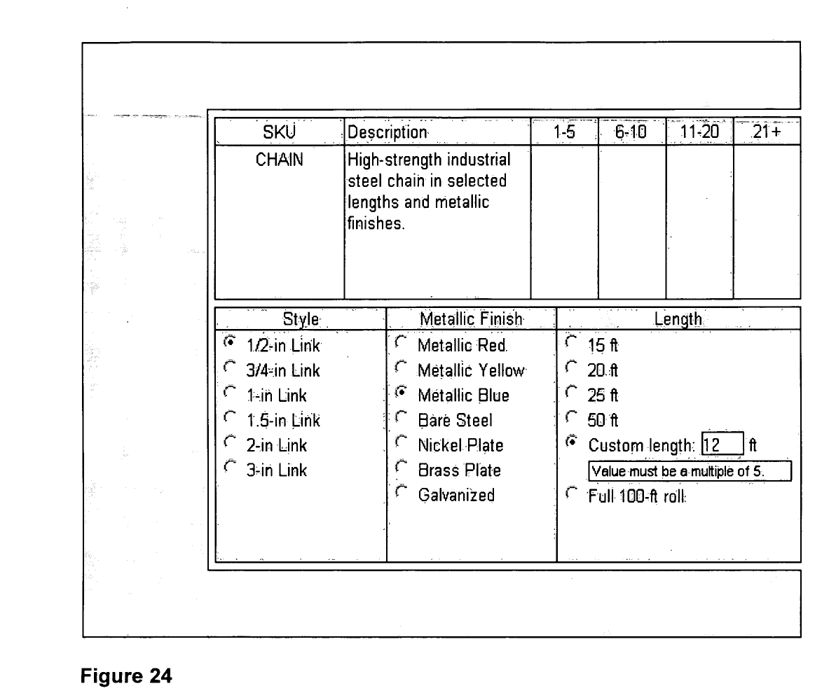

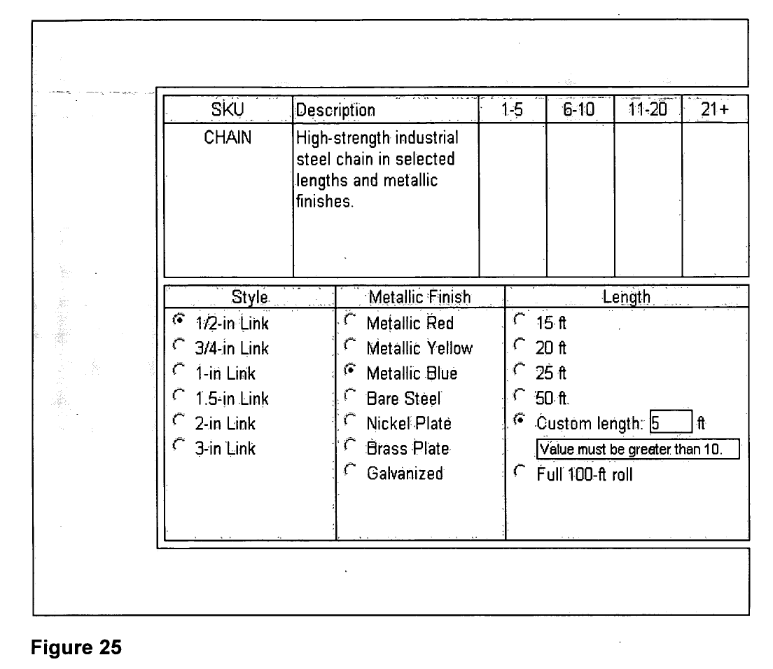

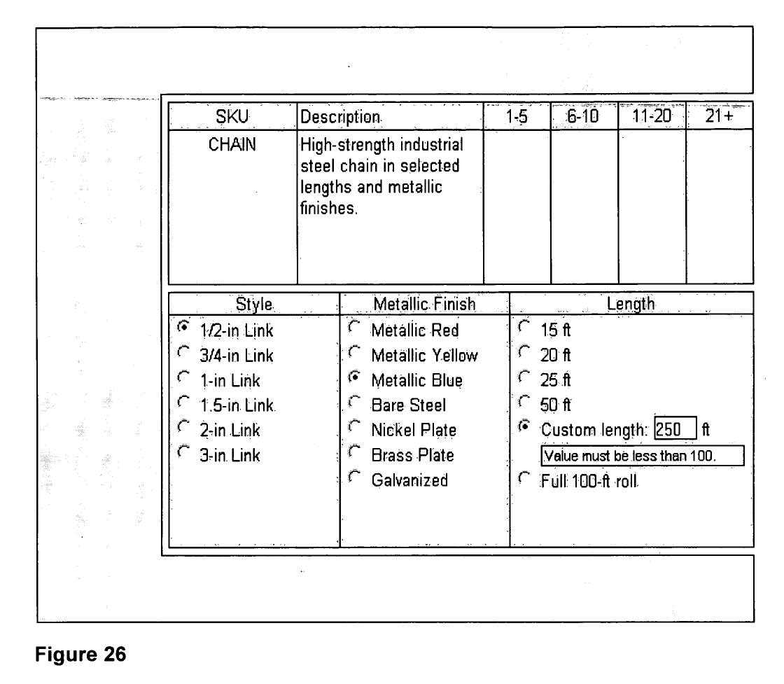

The end user decides to configure the product using the ‘Custom Length’ attribute, which triggers the display of a sub-variation to solicit a manually entered length. This causes the background color of the ‘Length’ variation to switch from yellow to green, indicating that the ‘Length’ variation has been configured, but the body of the syndicated object remains yellow because there is still a required manual entry. The user manually inputs ‘12’, as shown in FIG. 24, but the embedded validation function rejects that entry because it is not a multiple of ‘5’, displaying an alert for the end user. The user than manually inputs ‘5’ as shown in FIG. 25, but again, the embedded validation function rejects that entry because it is less than ‘10’, displaying an alert for the end user. The user then manually inputs ‘250’ as shown in FIG. 26, but again, the embedded validation function rejects that entry because it is greater than ‘100’.

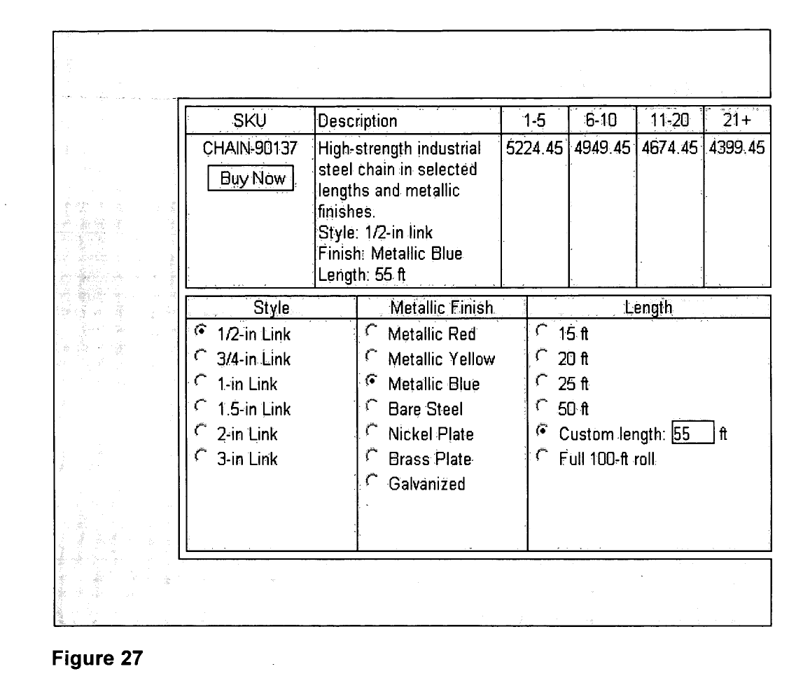

The end user then manually inputs ‘55’ as shown in FIG. 27, and this entry is accepted by the embedded validation function, which triggers a series of functions that reveal the ‘Buy Now’ button, making this product purchasable by the end user. The body of the syndicated object switches from yellow to green, indicating to the end user that all required configurations have been made, and the product can be purchased. Also dynamically displayed is pricing in four columns of tier pricing, as well as the SKU for the particular combination of variation attributes selected by the end user.

I claim:

1. A method of conducting electronic commerce comprising the steps of:
storing in a central computer system a record of a product with one or more variations, each of said variations having one or more variation attributes;
establishing an association between all valid combinations of variation attributes by identifying each said association with a unique metakey;
storing in said central computer system a plurality of product records, each of which is associated with a unique metakey for said product;
creating from said product records an executable software object that causes to be rendered, when executed by at least one recipient web browser, a display of said product in which one or more variation attributes are hidden from view but displayable when triggered by the selection of one or more other variation attributes;
storing in said central computer system a record of the software object;
creating on said central computer system a software command which, when inserted into a web page, causes the executable software object to be requested;
inserting into a web page said software command; and requesting said web page using a web browser.

2. A method as in claim 1 in which the software object contains executable code for calculating variable pricing based upon one or more units of measure, where such measures are manually entered by the end-user;

3. A method as in claim 1 in which one or metakeys is not unique to a single combination of variation attributes, but includes special characters recognized that allow it to be shared by two or more combinations of variation attributes;

4. A method of encoding and making selectable, within a single software object, all possible combinations of product variation attributes, comprising the steps of:
storing within a central computer system a parent record of the product containing a unique product identifier;
associating with said product identifier a record containing style information;
storing within a central computer system a record of the product variations and variation attributes, and associating them with said product identifier;
storing within a central computer system a record of statements associated with certain variation attributes that will cause to be solicited a manual entry from the end-user, the statements describing the methods by which said entry will be accepted or rejected;
determining all valid combinations of variation attributes;
assigning to said combination a unique metakey;
associating with said metakey and product identifier and storing within said central computer system a record describing fixed and/or variable pricing, for one or more tiers of pricing;
associating with said metakey and product identifier and storing within said central computer system a record containing one or more digitally encoded images;
associating with said metakey and product identifier and storing within said central computer system a record containing one or more digitally encoded documents;
creating a storing within said central computer an executable process object containing one or more arrays of pricing, descriptive, image and associated content variables, the keys of which include every metakey associated with said product;
adding to said process object functions that, when triggered by an event handler or function call, cause to be revealed or hidden certain elements of the rendered product;
adding to said process object functions that, when triggered by an event handler or function call, cause to be changed the textual content of certain elements of the rendered product;
adding to said process object functions that, when triggered by an event handler or function call, cause to be changed the visible style of certain elements of the rendered product;
adding to said process object functions that, when triggered by an event handler or function call, cause to be changed the background color of the most recently selected variation, such that the end-user is given visual indication of the status of overall product configuration;
adding to said process object functions that, when triggered by an event handler or function call, cause to be validated a manual entry of data by the end user;
adding to said process object functions that, when triggered by an event handler or function call, cause to be changed, within certain elements of the rendered product, pricing, descriptive data, images and links to associated content;
adding to said process object functions that, when triggered by an event handler or function call, cause to be changed the value of one or more visible or hidden form elements;
adding to said process object functions that, when triggered by an event handler or function call, cause to be changed the SRC of one or more images;
creating and storing within said central computer a style object derived from a style record associated with the product identifier;
creating and storing within said central computer a product object derived from the parent record of said product, using certain elements from a style record associated with said product identifier;
creating and storing within said central computer a single software object aggregated from said product object, process object and style object;

5. A method as in claim 4 in which the software object contains executable code for validating the value of one or more units of measure, where such measures are manually entered by the end-user, and where such measures must fall between a minimum and maximum value;

6. A method as in claim 5 in which the validation of manually entered measures checks that said measures are evenly divisible by a pre-set number referenced in the executable code of the software object;

7. A method as in claim 5 in which the validation of manually entered measures checks that said measures are checked for conformity against a series of mathematical operations referenced in the executable code of the software object;

8. A method as in claim 4 in which the software object contains executable code for validating one or more end-user inputs, where such validation checks that inputs contain only characters from a pre-determined set of characters;

9. A method as in claim 8 in which the software object contains executable code validating one or more end-user inputs, where such validation checks inputs against a mapping of ‘known valid’ combinations of one or more characters;

10. A method as in claim 8 in which the software object contains executable code validating one or more end-user inputs, where such validation checks inputs against a mapping of ‘known invalid’ combinations of one or more characters;

11. A method as in claim 4 in which the software object contains executable code validating one or more numerical end-user inputs, in which successful validation triggers a mathematical operation upon said input;

12. A method as in claim 4 in which the software object contains executable code validating one or more alphabetical end-user inputs, in which successful validation triggers a string operation upon said input;

13. A method as in claim 4 in which the software objects contains executable code that causes to be displayed a summary of selected variation attributes in one or more areas of the product object;

14. A method as in claim 13 in which the summary of selected variation attributes is encoded into hidden form elements within the web page;

15. A method as in claim 13 in which the summary of selected variation attributes is encoded into a dynamic SRC reference, and passed to a non-visible image on the web page, causing to be transmitted to another computer said summary of selected variation attributes;

16. A method as in claim 15 in which the value of a single selected variation attribute is encoded immediately upon being selected by the end user;

17. A method as in claim 15 in which the value of a manual input, after being successfully validated, is encoded into a dynamic SRC reference;

18. A method as in claim 17 in which the value of a manual input, after being successfully validated and having one or more mathematical operations performed upon it, is encoded into a dynamic SRC reference;

19. A method as in claim 18 in which the visible ‘image’ or ‘submit’ type of form element, when clicked, causes one or more commands to be encoded into a dynamic SRC reference and passed to a non-visible image on the web page, causing to be transmitted to another computer knowledge of the visible button or image being clicked;

20. A method as in claim 13 in which the successful configuration of a combination of variation attributes causes to be displayed a visible form entry or selection element that is recognized by an E-Commerce system resident on the merchant web server;

21. A method as in claim 20 in which the visible ‘image’ or ‘submit’ type of form element, when clicked, causes one or more commands to be encoded into a dynamic SRC reference and passed to a non-visible image on the web page, causing to be transmitted to another computer knowledge of the visible button or image being clicked;

22. A method as in claim 13 in which the successful configuration of a combination of variation attributes causes to be displayed a visible form entry or selection element that is recognized by an E-Commerce system resident on the merchant web server;

23. A method as in claim 22 in which the successful configuration of a combination of variation attributes causes to be changed the value of a hidden form element;

24. A method as in claim 4 in which the software object contains executable code that displays different tier quantity thresholds for one or more combinations of variations;

25. A method as in claim 4 in which the software object contains executable code that displays the means by which a customer can select from one or more pricing schedules, such selection causing to be changed the pricing displayed in one or more columns within the product object;

26. A method as in claim 4 in which the software object contains executable code that renders within a single product object one or more combinations of variation attributes in which at least one said combination has a fixed price and as least one other said combination has a variable price, or is otherwise priced by a unit of measure requiring the input of one or more units of measures by the end user;

27. A method as in claim 4 in which the software object contains executable code that calculates pricing for a selected combination of variation attributes using one or more series of mathematical operations, causing said pricing to be displayed within the product object;

28. A method as in claim 4 in which the software object contains executable code that permits all elements of a ‘radio’ type of form element to be unselected by clicking on the currently selected element;

29. A method as in claim 4 in which the software object contains executable code that displays different images for one or more combinations of variation attributes;

30. A method as in claim 4 in which the software object contains executable code that causes to be displayed, within the product object, an explanation of how variable pricing was calculated based upon a manual input of a unit of measure by the end user;

31. A method as in claim 4 in which the software object contains executable code that causes to be displayed a graphical object for manually entering an automatically validated numerical entry, where said graphic object is comprised of a sliding element that is maneuvered by the end user either horizontally or vertically, where such movement increases or decreases the value of the numerical entry in pre-defined mathematical increments, not moving beyond a set maximum nor below a set minimum;

32. A method as in claim 31 in which the graphic object is a rotating knob that is maneuvered by the end user either clockwise or counterclockwise, where such movement increases or decreases the value of the numerical entry in pre-defined mathematical increments, not moving beyond a set maximum nor below a set minimum;

33. A method for associating a combination of product variation attributes to variable product-related information using a self-descriptive metakey, comprising the steps of:
storing within a central computer system a custom character map consisting of a subset of 128 unique characters from the ASCII character set, mapped to values between 1 and 128;
storing within said central computer system a parent record of the product containing a unique product identifier;
storing within said central computer system a record of the product variations and variation attributes, and associating them with said product identifier;
determining all valid combinations of variation attributes;
determining the sequence of each variation in the hierarchy of all variations;
determining the sequence of each variation attribute in the hierarchy of all variation attributes for each variation;
mapping a character from said character map to each unique variation with a hierarchical value of 128 or less;
determining the proper multi-byte representation, based on characters from a custom character map, for each unique variation with a hierarchical value of 129 or more;
inserting opening and closing dashes around each non-unique variation, and mapping the variation attributes contained within against their assigned value in said character map;
storing within said central computer system one or more records for each derived metakey, associating each with said product identifier and variable product-related information;
storing within a central computer system a custom character map consisting of a subset of 128 unique characters from the ASCII character set, mapped to values between 1 and 128;
storing within said central computer system a parent record of the product containing a unique product identifier;
storing within said central computer system a record of the product variations and variation attributes, and associating them with said product identifier;
determining all valid combinations of variation attributes;
determining the sequence of each variation in the hierarchy of all variations;
determining the sequence of each variation attribute in the hierarchy of all variation attributes for each variation;
mapping a character from said character map to each unique variation with a hierarchical value of 128 or less;
determining the proper multi-byte representation, based on characters from a custom character map, for each unique variation with a hierarchical value of 129 or more;
inserting opening and closing dashes around each non-unique variation, and
mapping the variation attributes contained within against their assigned value in said character map;
storing within said central computer system one or more records for each derived metakey, associating each with said product identifier and variable product-related information;

34. A system for retrieving, from a central computer system, a software object that causes to be rendered, when executed by at least one recipient browser, a visual display of a product with one or more variations, comprising:
Storage means on said central computer system for product records;
Authentication means on said central computer system by which access to functions and records is controlled;
Storage management means by which access to various storage means by various authenticated human and non-human users is controlled;
Input means located at central computer system for allowing authenticated human users to perform read/write actions on said product records;
Input means located at central computer system for allowing authenticated non-human users to perform read/write actions on said product records;
Software code that parses a request from an authenticated human or non-human user, and passes the components of the request to other software code for further processing;
Software code that presents retrieved content from various storage means in human-readable form;
Software code that presents retrieved content from various storage means in machine-readable form;
Software code that creates associations between valid combinations of product variation attributes, creating unique metakeys to identify such associations within various product records;
Software code that creates executable software objects from said product records;
Software code that creates executable code within software objects, with such execution triggered by an event handler or function call;
Input means located at central computer system for allowing browsers to request software objects from said storage means;
Software code that responds to browser requests for software objects, retrieving said objects and delivering back to requesting browser;
